(19) United States
(12) Patent Application Publication
(10) Pub. No.: US 2007/0223465 A1
(43) Pub. Date: Sep. 27, 2007

(54) System, method and article for VOIP and PSTN communication

(76) Inventors: Lee Wang, Kirkland, WA (US); Yuhui Wang, Kirkland, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/726,113

(22) Filed: Mar. 20, 2007

Related U.S. Application Data
(60) Provisional application No. 60/784,962, filed on Mar. 21, 2006.

(51) Int. Cl. H04L 12/66

(52) U.S. Cl. 370/356

(57) ABSTRACT

A VOIP/PSTN system is configured to allow analog telephones connected to an existing analog premises telephone network to place and receive VOIP and PSTN telephone calls through the analog premises telephone network. In one embodiment, the system is configured to selectively disconnect the premises telephone network from the PSTN.

### BACKGROUND OF THE INVENTION

1. Field of the Invention

This disclosure generally relates to system and method for voice over Internet protocol (VOIP) and public switched telephone network (PSTN) communications and more particularly to a system and method for avoiding interference between VOIP and PSTN signals and devices.

2. Description of the Related Art

The PSTN is a system that is configured to carry, inter alia, analog voice data. It is sometimes called the plain old telephone system (POTS). VOIP is a newer technology that facilitates digital voice communication, and in particular, the communication of voice data over the Internet.

Conventional PSTN and VOIP communication systems and devices are not compatible. Conventional VOIP systems typically cannot use existing telephones compatible with the PSTN, and conventional VOIP devices, such as computers, are not compatible with the PSTN. Furthermore, home PSTN telephone systems and home broadband networks typically are completely separate from each other to avoid interference between and damage to incompatible systems and devices. A homeowner cannot use the existing home telephone network to receive VOIP phone calls or connect VOIP equipment, and must use separate telephones for each type of call.

### BRIEF SUMMARY OF THE INVENTION

In one embodiment, existing analog phone networks may be used for making and receiving both PSTN and VOIP calls, without requiring special and more expensive phones that support the VOIP protocol. In one embodiment, plain analog phones that previously worked only for PSTN will also work for VOIP seamlessly, without requiring reconfiguring of these analog phones or changes to the connection of the analog phone to the analog phone network. An embodiment automatically detects and distinguishes PSTN calls and VOIP calls. In an embodiment, users can make and receive both PSTN and VOIP calls on an analog phone network that previously supported only PSTN calls.

In an embodiment, VOIP call functionalities are embedded in a VOIP/PSTN system. After the system hardware is installed and minimal configuration (such as setting up a VOIP user account) is completed (for example, via a provided Web-based Subscriber User Interface), users can start to make both PSTN and VOIP calls. In one embodiment, a VOIP/PSTN system is a “plug-and-play” system. For example, the system may automatically connect to a server and retrieve configuration information.

In an embodiment, VOIP/PSTN system embedded software and firmware may be remotely updated, for example, over the Internet. Thus, a service provider (such as a carrier or a provider of the VOIP/PSTN system, which may or may not be the same entity) may improve the embedded software and update features and functionalities for a better user experience as desired. In an embodiment, the VOIP/PSTN system may embed VOIP client software from a VOIP service provider. For example, a provider of the VOIP/PSTN system may remotely switch a carrier for the VOIP service.

In one embodiment, a voice-over-internet-protocol (VOIP)/public-switching-telephone-network (PSTN) control system comprises: a VOIP/PSTN interface comprising a first port configured to receive and transmit VOIP-compatible communication signals, a second port configured to receive and transmit PSTN-compatible communication signals, a VOIP client module configured to convert received VOIP-compatible communication signals and to convert PSTN-compatible communication signals, and a communication module configured to generate control signals to control coupling of a premises analog phone network to a PSTN provider network, and a network-interface-unit-controller configured to selectively couple the premises analog phone network to the PSTN provider network in response to the control signals. In one embodiment, the communication module is configured to output the control signals through the second port. In one embodiment, the communication module comprises a solid-state frequency generator configured to generate control signals. In one embodiment, the network-interface-unit-controller comprises a solid-state frequency detector configured to detect control signals. In one embodiment, the control signals comprise signals within a frequency range selected to avoid interference with other signals. For example, in some embodiments a frequency range of 10 kHz to 25 kHz may be selected to avoid interference with other common PSTN signals.

In one embodiment, a VOIP/PSTN interface comprises a first port configured to receive and transmit voice-over-internet-protocol-compatible signals, a second port configured to receive and transmit public-switching-telephone-network-compatible analog voice signals, a client module configured to convert voice-over-internet-protocol-compatible signals and to convert public-switching-telephone-network-compatible analog voice signals, and a communication module configured to generate control signals to control coupling of a premises analog phone network to a public-switching-telephone-network. In one embodiment, the communication module is configured to transmit control signals through the second port. In one embodiment, the communication module comprises a solid-state frequency generator configured to generate control signals. In one embodiment, the communication module comprises a solid-state frequency detector configured to detect control signals. In one embodiment, the interface further comprises a diode or switch configured to control coupling of the interface to the premises phone network. In one embodiment, the second port is configured to provide a voltage of approximately 4 volts to the premises phone network. In one embodiment, the control signals comprise synchronization signals. In one embodiment, the communication module comprises a wireless transceiver configured to transmit the control signals. In one embodiment, the wireless transceiver is configured to receive the control signals. In one embodiment, the first port comprises a wireless transceiver. In one embodiment, the second port comprises a wireless transceiver. In one embodiment, the interface further comprises a controller configured to selectively couple the premises phone network to the public-switching-telephone-network in response to the control signals.

In one embodiment, a controller comprises a first port configured to couple to an analog premises phone network, a second port configured to couple to a public-switching-telephone-network, and a switch module configured to respond to control signals by selectively controlling the transmission of signals between the first port and the second port. In one embodiment, the second port is configured to couple to a network-interface-unit. In one embodiment, the switch module comprises a relay configured to selectively open a connection between the first port and the second port in response to the control signals.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not necessarily intended to convey any information regarding the actual shape of particular elements, and have been selected solely for ease of recognition in the drawings.

FIG. 1 is a functional block diagram of a typical prior art residential communications system.

FIG. 2 is a functional block diagram of a prior art hardware-based VOIP system.

FIG. 3 is a functional block diagram of a prior art software-based VOIP system.

FIG. 4 is a functional block diagram of a prior art VOIP adapter-based VOIP system.

FIG. 5 is a functional block diagram of a prior art VOIP phone network system.

FIGS. 6 through 8 illustrate a typical prior art PSTN network interface unit (NIU).

FIG. 9 is a functional block diagram of an embodiment of a VOIP/PSTN premises communication system.

FIG. 10 is a functional block diagram of an embodiment of a VOIP/PSTN interface.

FIG. 11 is a functional block diagram of an embodiment of a network interface unit controller.

FIG. 12 illustrates an embodiment of a method of operating a premises communication system in response to a PSTN call.

FIG. 13 illustrates an embodiment of a method of disabling VOIP use of a premises communication system.

FIG. 14 illustrates an embodiment of a method of operating a premises communication system to service a PSTN call.

FIG. 15 illustrates an embodiment of a method of operating a premises communication system to service a VOIP call.

FIG. 16 illustrates an embodiment of a method of operating a premises communication system to service an inbound PSTN call.

FIG. 17 illustrates an embodiment of a method of operating a premises communication system to service an inbound VOIP call.

FIG. 18 illustrates an embodiment of a method of operating a premises communication system to service an outbound call.

### DETAILED DESCRIPTION OF THE INVENTION

In the following description, certain details are set forth in order to provide a thorough understanding of various embodiments of devices, methods and articles. However, one of skill in the art will understand that other embodiments may be practiced without these details. In other instances, well-known structures and methods associated with the PSTN, VOIP, the Internet, networks, communication devices, integrated circuits, computer systems, telephones, and control systems have not been shown or described in detail to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is as “including, but not limited to.”

Reference throughout this specification to “one embodiment,” or “an embodiment” means that a particular feature, structure or characteristic described in connection with the embodiment is included in at least one embodiment. Thus, the appearances of the phases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure or the claimed invention.

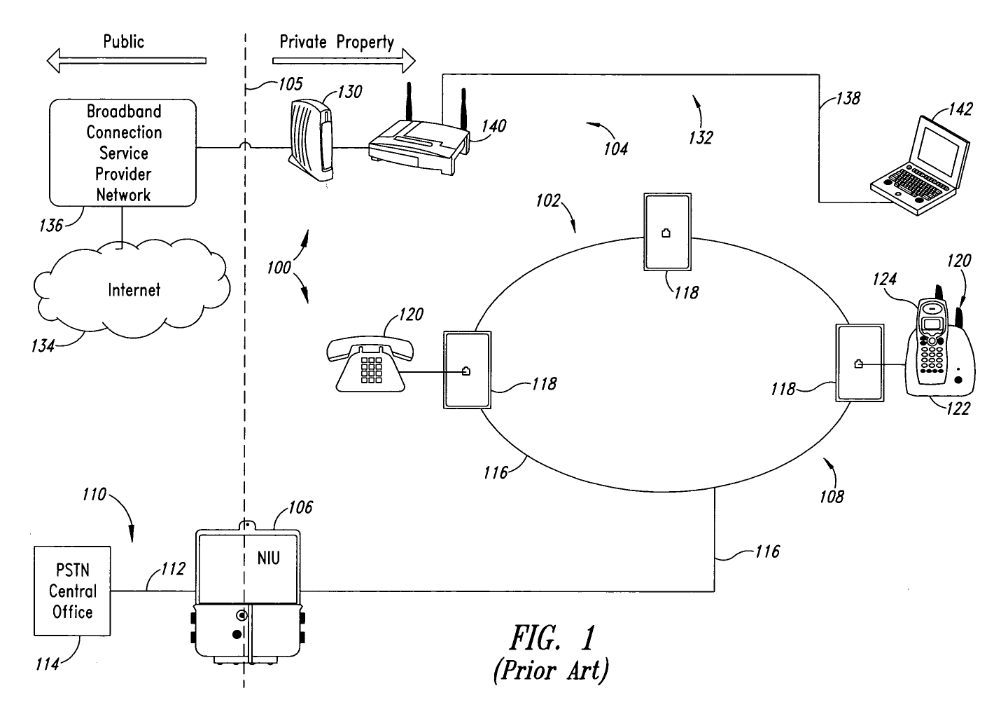

FIG. 1 is a functional block-diagram of a communications system 100 typically employed in residential settings. The communications system 100 comprises an analog phone network 102 for PSTN service and a separate broadband network 104 for VOIP service. The components to the left of the dashed line 105 typically are owned by a carrier, such as a PSTN phone carrier and a broadband Internet service provider, while the components to the right of the dashed line 105 typically are owned by the customer or the owner of the premises. The components of the system, however, may be owned by anyone.

In PSTN telephone networks, the demarcation point is where the telephone company's local loop network ends and connects with the telephone system or wiring at the customer's premises. In most cases, everything up to and including the demarcation point is owned by the carrier, and everything past it is owned by the property owner. The demarcation point varies from building type and service level. At a typical residential house, the demarcation point is a box normally mounted on the outside wall (in recent years, as close to the electrical ground as possible). This box is referred to as the Network Interface Unit (NIU) or, interchangeably, Network Interface Device (NID), the Demarc Box, etc. Apartments and businesses with multiple lines would typically have a punch-down block in an equipment room, though recent changes in policies have resulted in either the first jack serviced or a special jack designed for the function as a demarcation point in the premises. An NIU is typically a weatherproof unit mounted outdoors where the telephone service wires enter a residence or business. Usually the NIU is a gray box positioned near the electric meter.

Referring to FIG. 1, the analog phone network 102 network typically comprises a PSTN network interface unit (NIU) 106, and a premises phone network 108. The NIU 106 electrically couples the premises phone network 108 to the PSTN 110. The PSTN 110 typically comprises one or more cables, such as the cable 112, and one or more switching centers, such as PSTN central office 114. The cables of the PSTN 110 may include, for example, copper wire and/or fiber-optic cables. Well-known structures and methods associated with the PSTN 110 have not been shown or described in detail to avoid unnecessarily obscuring this description. In some configurations, the NIU 106 may be part of the PSTN 110, that is, it may be owned by a carrier operating a portion of the PSTN, with a customer allowed to have access to a portion of the NIU 106. The premises phone network 108 typically comprises wiring 116, one or more phone jacks 118, and one or more analog phones 120, which may include one or more cordless phones with a base station 122 and a headset 124. The wiring 116 may comprise, for example, copper wire. Analog phones 120 coupled to the premises phone network 108 in FIG. 1 may be used with PSTN calls, but may not be used with VOIP calls.

The broadband network 104 typically comprises a modem 130 configured to couple a local area network 132 to the Internet 134 through a broadband service provider network 136. Various types of broadband service provider networks may be employed, such as, for example, cable, DSL, WI-FI and satellite communication service provider networks. Well-known structures and methods associated with the broadband service provider network 136 have not been shown or described in detail to avoid unnecessarily obscuring this description. The local area network 132 typically comprises cabling 138 and/or a broadband router 140 configured to communicatively couple a VOIP device, such as a computer 142, through the modem 130 to the Internet 134. In some embodiments, the modem 130 and the broadband router 140 may be combined. In some embodiments, wireless communication links may be employed.

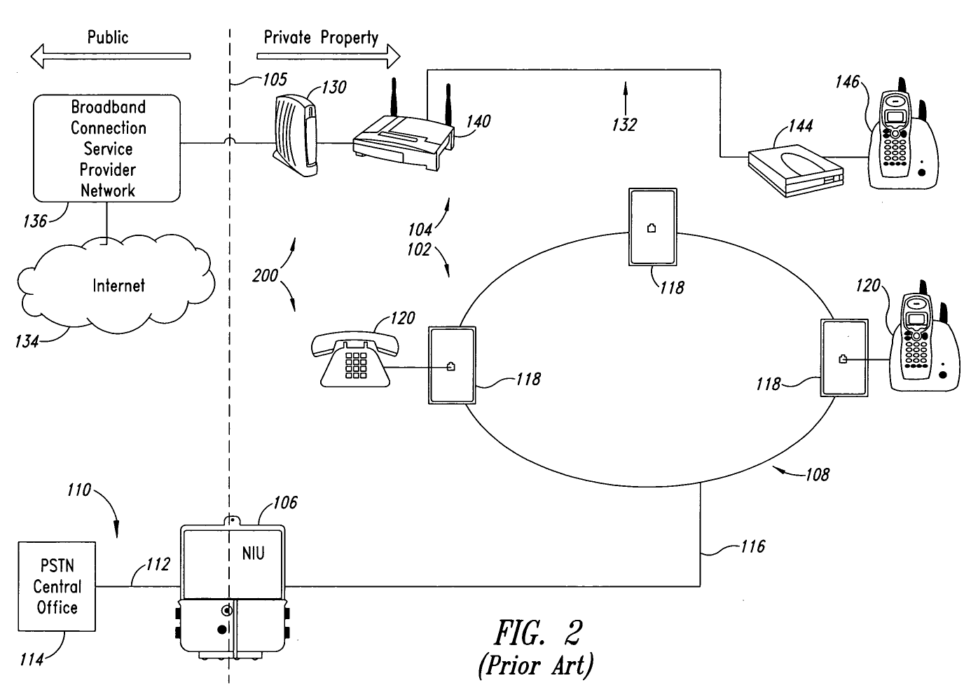

FIG. 2 is a functional block diagram of a communications system 200 illustrating a hardware VOIP connection, and is similar in some respects to FIG. 1. FIG. 2 is a typical solution employed by hardware VOIP carriers, such as VONAGE™. The system 200 comprises an analog phone network 102 and a broadband network 104. The local area network 132 comprises a hardware adapter 144 configured to couple a conventional telephone 146 to the local area network. The hardware adapter 144 is communicatively coupled to the broadband router 140 and is configured to convert digital signals using VOIP protocols to analog signals using PSTN protocols (such as SS5 signals) and vice versa to facilitate VOIP communications using the conventional telephone 146.

In the system 200 of FIG. 2, both an analog phone network 102 and a broadband network 104 are required. The conventional telephone 146 is not connected to the premises phone network 108 and cannot be used to place or receive PSTN communications. Similarly, conventional telephones 120 coupled to the premises phone network 108 cannot be used for VOIP communications.

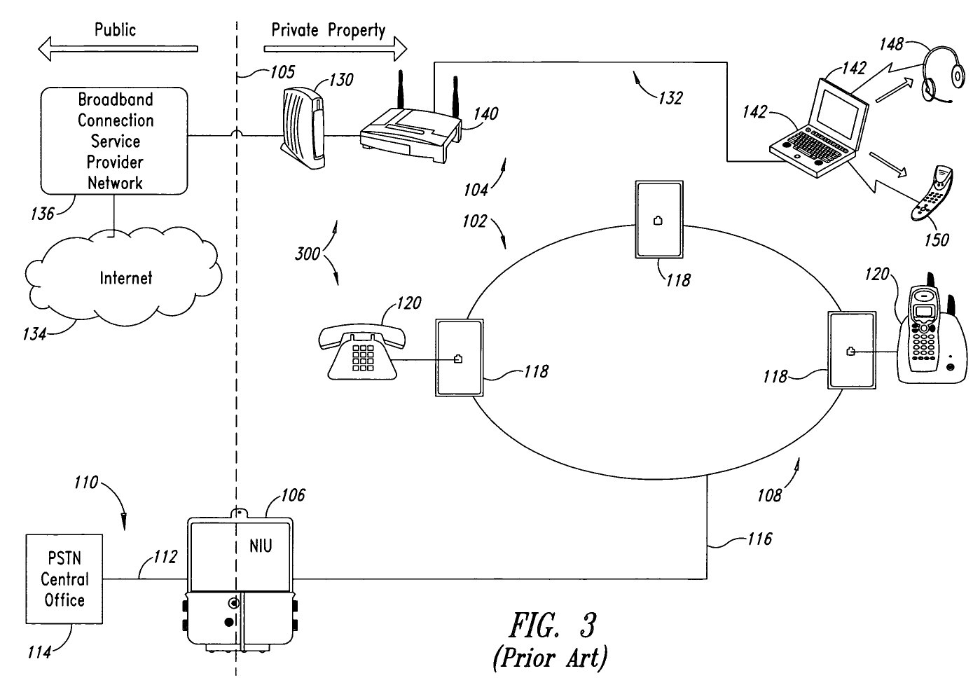

FIG. 3 is a functional block diagram of a communications system 300 illustrating a software VOIP connection, and is similar in some respects to FIG. 1. FIG. 3 is a typical software solution employed by software VOIP carriers, such as SKYPE™. The system 300 comprises an analog phone network 102 and a broadband network 104. The computer 142 is configured to run VOIP software, such as VOIP service client software. Devices such as headset 148 and VOIP phone 150 are communicatively coupled to the computer 142. This facilitates VOIP communications using the headset 148 and/or the VOIP phone 150. The computer 142 may be configured for direct VOIP communications.

In the system 300 of FIG. 3, the computer 142 must be running for VOIP communications to be sent or received, and both an analog phone network 102 and a broadband network 104 are required to have both PSTN and VOIP service. The computer 142, the headset 148 and the VOIP phone 150 cannot be used for PSTN communications, and the conventional telephones 120 coupled to the premises phone network 108 cannot be used for VOIP communications.

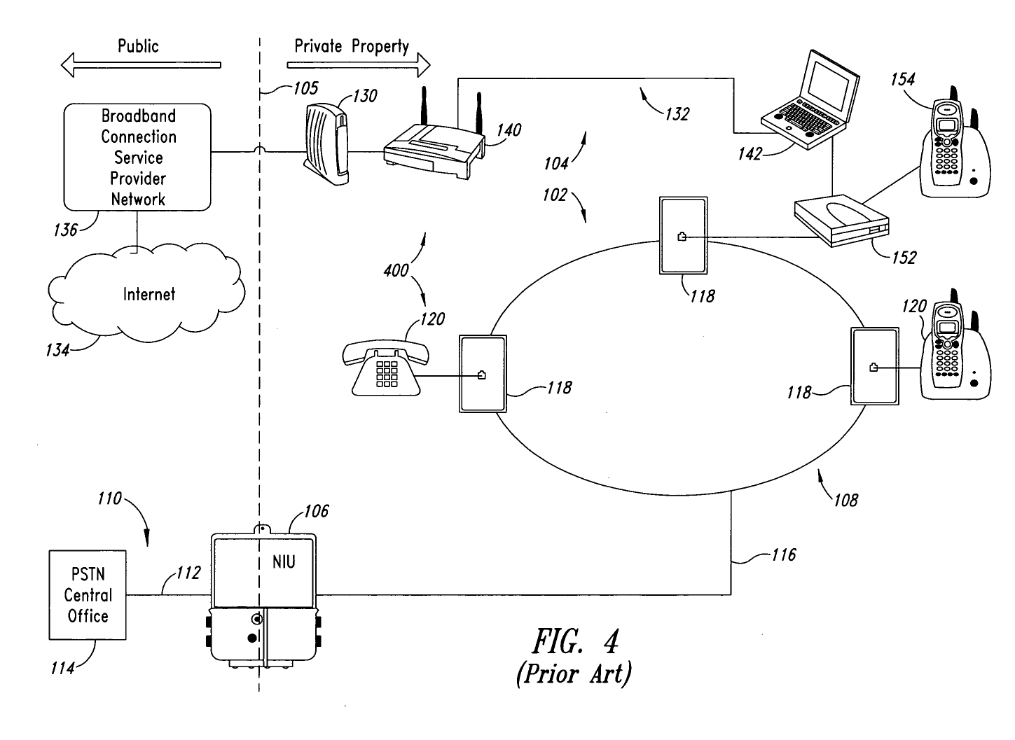

FIG. 4 is a functional block diagram of a communications system 400 illustrating a hardware/software solution, and is similar in some respects to FIG. 1. The system 400 comprises an analog phone network 102 and a broadband network 104. The computer 142 is configured to run VOIP software. An adapter 152 is communicatively coupled to the computer 142, the premises phone network 108 and a conventional telephone 154. The adapter 152 is configured, for example, by embedded software or a hardware switch, to connect the telephone 154 to only one of the computer 142 or the premises phone network 108 at a time. FIG. 4 is a typical solution employed by some VOIP carriers, such as SKYPE™. For example, the computer 142 may run SKYPE™ client software to control a SKYPE™-compatible adapter (from, for example, a third-party manufacturer).

In the system 400 of FIG. 4, the telephone 154 coupled to the adapter 152 can be used to place either VOIP or PSTN calls, but other telephones 120 coupled to the premises phone network 108 cannot be used for VOIP communications. In addition, both the analog phone network 102 and the broadband network 104 are required.

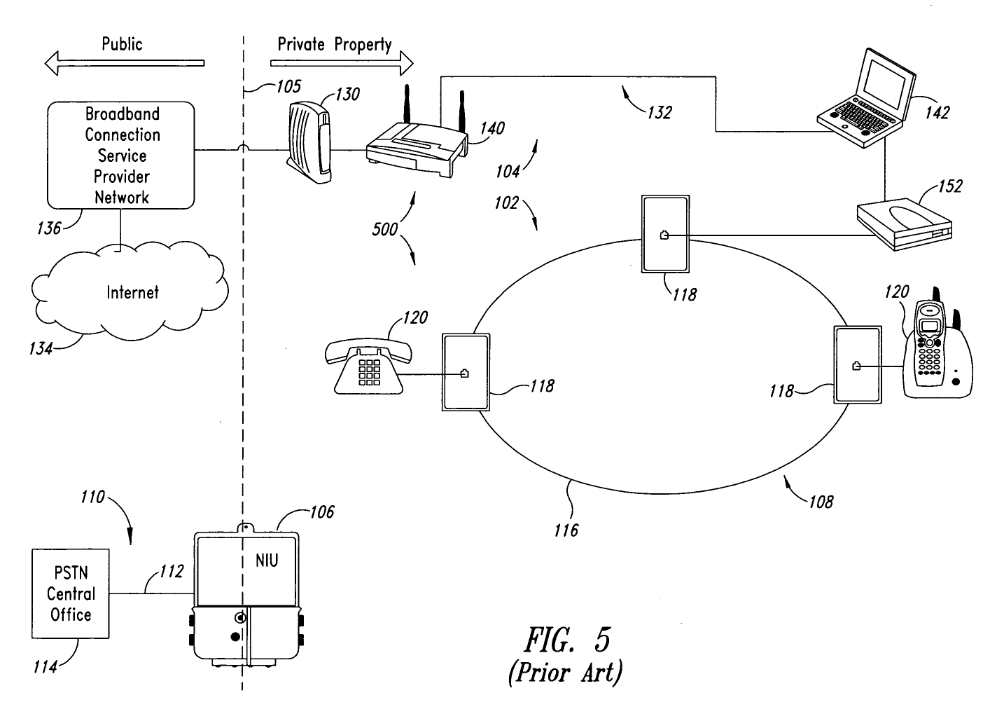

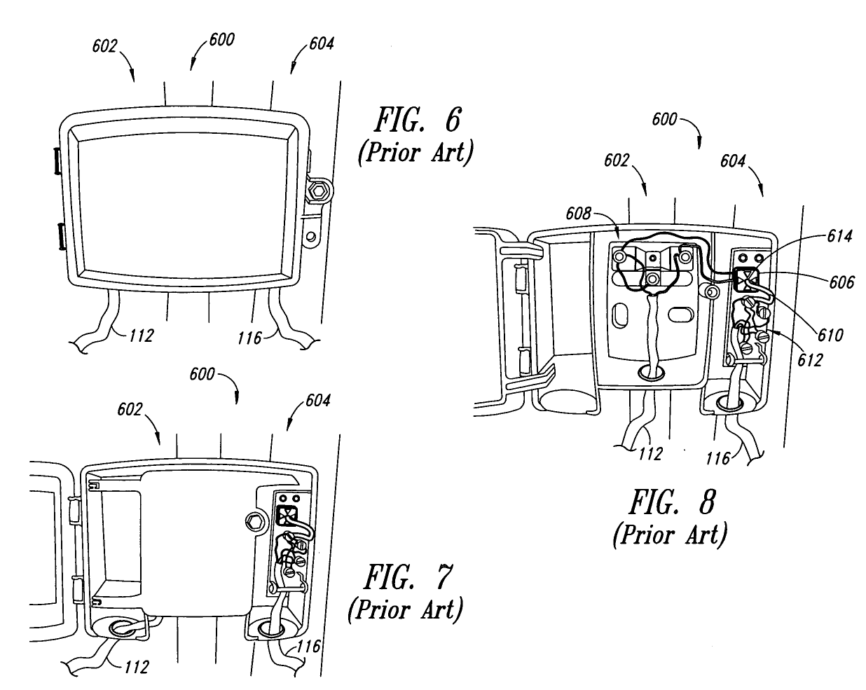

FIG. 5 is a functional block diagram of a communication system 500 illustrating a VOIP only configuration. The premises phone network 108 is not connected to the PSTN 110. This may be done, for example, by disconnecting the premises phone network 108 from the NIU 106. For example, a short cord in the NIU 106 may be unplugged from a connector, as discussed in more detail in the description of FIGS. 6-8 below. Because the premises phone network 108 is no longer connected to the PSTN 110, the telephones 120 connected to the premises phone network 108 can be used for VOIP communications, but cannot be used for PSTN calls. If the premises phone network 108 remained connected to the PSTN 110, equipment may be damaged and the PSTN 110 would interfere with VOIP communications. For example, a message from the PTSN indicating that a call cannot be completed as dialed may be heard when an attempt is made to initiate a VOIP communication using one of the telephones 120. FIG. 5 illustrates a software VOIP configuration, but a hardware VOIP configuration similar to that illustrated in FIG. 2 may be employed.

FIGS. 6 through 8 illustrate an embodiment of a typical NIU 600 that may be employed by the analog phone network 102. Well-know structures and methods associated with NIUs have not been shown or described in detail to avoid unnecessarily obscuring this description. FIG. 6 illustrates the NIU 600 with access to its PSTN connection side 602 and its premises connection side 604 closed. FIG. 7 illustrates the NIU 600 with access to its PSTN connection side 602 closed and access to its premises connection side 604 open. FIG. 8 illustrates the NIU 600 with access to both the PSTN connection side 602 and the premises connection side 604 open. A first connector 606, typically an RJ-11 socket, in the premises connection side 604 is wired to a first set of terminals 608 in the PSTN connection side 602 to electrically coupled the PSTN connection side 602 to the premises connection side 604. A short cord 610 is wired to a second set of terminals 612 in the premises connection side 604 and comprises a second connector 614, typically an RJ-11 plug, configured to mate with the first connector 606 in a weather-resistant manner. The second set of terminals 612 is electrically coupled to a premises phone network (see premises phone network 108 in FIG. 1). Thus, the premises phone network (see premises phone network 108 in FIG. 1) may be connected to the PSTN (see PSTN 110 in FIG. 1) by plugging the second connector 614 into the first connector 606. Similarly, the premises phone network 108 may be disconnected from the PSTN by unplugging the second connector 614 from the first connector 606. Some embodiments may employ multiple sets of terminals, connectors and/or short cords. In some embodiments, an NIU may comprise a set of terminals that may be configured to electrically couple the PSTN to the premises phone network. The premises phone network may be disconnected from the PSTN by disconnecting wires coupled to the premises phone network from the terminals.

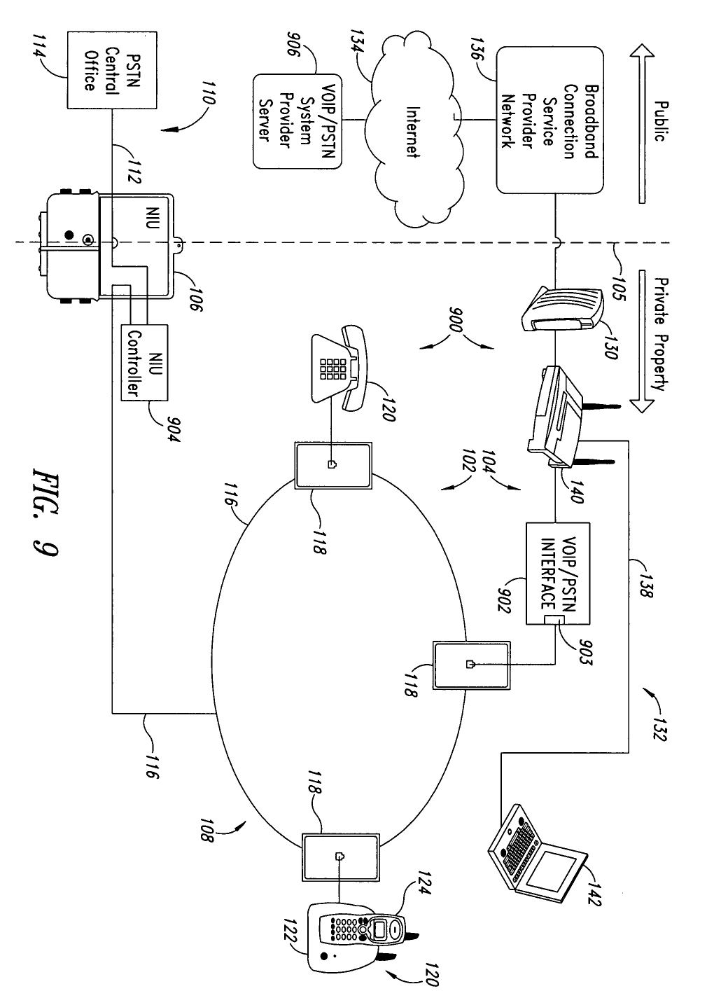

FIG. 9 is a functional block diagram of an embodiment of a premises communication system 900. The system 900 comprises an analog phone network 102 and a broadband network 104. The analog phone network 102 network comprises a PSTN network interface unit (NIU) 106, and a premises phone network 108. The NIU 106 communicatively couples the premises phone network 108 to the PSTN 110. The PSTN 110 typically comprises one or more cables, such as the cable 112, and one or more switching centers, such as PSTN central office 114. The cables of the PSTN 110 may include, for example, copper wire and/or fiber-optic cables. Well-known structures and methods associated with the PSTN 110 have not been shown or described in detail to avoid unnecessarily obscuring this description. In some configurations, the NIU 106 may be part of the PSTN 110, that is, it may be owned by a carrier operating a portion of the PSTN 110, with a customer allowed to have access to a portion of the NIU 106. The premises phone network 108 is configured to carry analog PSTN communications, and typically comprises wiring 116, one or more phone jacks 118, and one or more analog phones 120, which may include one or more cordless phones with a base station 122 and a headset 124. The wiring 116 may comprise, for example, copper wire. As discussed in more detail below, the system 900 allows conventional analog telephones, for example, analog phones 120, coupled to the premises phone network 108, to send and receive both PSTN and VOIP calls.

The broadband network 104 illustrated comprises a modem 130 configured to couple a local area network 132 to the Internet 134 through a broadband service provider network 136. Various types of broadband service provider networks may be employed, such as, for example, cable, DSL and satellite communication service providers. Well-known structures and methods associated with broadband service provider networks, such as the broadband service provider network 136, have not been shown or described in detail to avoid unnecessarily obscuring this description. The local area network 132 typically comprises cabling 138 and/or a broadband router 140 configured to communicatively couple a VOIP capable device, such as a computer 142, through the modem 130 to the Internet 134. In some embodiments, the modem 130 and the broadband router 140 may be combined. In some embodiments, wireless communication links may be employed.

The system 900 also comprises a VOIP/PSTN interface 902 and an NIU controller 904. The VOIP/PSTN interface 902 is communicatively coupled to the broadband router 140 and to the premises phone network 108 and is configured to convert digital signals using VOIP protocols to analog signals using PSTN protocols (such as SS5 signals) and vice versa to facilitate VOIP communications using conventional telephones 120 coupled to the premises phone network 108. In some embodiments, circuitry 903, such as a diode or a filter, may be employed to block reverse current flow from the premises phone network 108 to the VOIP/PSTN interface 902 when both the VOIP/PSTN interface 902 and the PSTN 110 are coupled to the premises phone network 108. For example, as discussed in more detail below, both the VOIP/PSTN interface 902 and the PSTN 110 may be coupled to the premises phone network for selected periods of time. Blocking reverse current flow from the VOIP/PSTN interface when the PSTN is applying a dial tone can reduce or eliminate dual dial tones that may be generated while the system determines whether an outbound call should be processed by a VOIP service provider or by the PSTN. The circuitry 903 may be incorporated into the VOIP/PSTN interface 902.

The VOIP/PSTN interface 902 is communicatively coupled to and configured to communicate with the NIU controller 904. For example, the VOIP/PSTN interface and the NIU controller 904 may communicate through the premises phone network 108 using frequencies outside the voice range. Other communication channels and protocols may be employed, such as RF, IR, WI-FI and BlueTooth™ channels and protocols. The NIU controller 904 is electrically coupled between the premises phone network 108 and the PSTN 110 and is configured to selectively disconnect and connect the premises phone network 108 to the PSTN 110 based on communications with and/or the status of the VOIP/PSTN interface 902, as discussed in more detail below. For example, the VOIP/PSTN interface 902 may detect the initiation of a VOIP communication and generate control signals to cause the NIU controller 904 to disconnect the premises phone network 108 from the PSTN 110. In another example, the NIU controller 904 may respond to a failure of the broadband network (such as a power outage, an Internet outage or a failed attempt to place a VOIP call) by automatically connecting the premises phone network 108 to the PSTN 110. When a PSTN communication is initiated or detected, the VOIP/PSTN interface 902 may be configured to disable VOIP communications.

The system 900 may be configured to always route or to first attempt to route particular types of calls through a particular service. For example, the system 900 may be configured to route calls to certain numbers, such as 911 calls or calls to numbers on a calling plan, to a desired provider, such as the PSTN. In another example, the system 900 may be configured to attempt to route certain types of calls, such as long distance calls, to a desired provider, such as a VOIP provider. When a call routed to a preferred provider fails, the system 900 may be configured to automatically reroute the call, to prompt for instructions, and/or to generate an error message. For example, the system 900 may be configured to respond to a failed attempt to place a call through a first VOIP service provider by attempting to place the call through a second VOIP provider or attempting to place the call through the PSTN.

FIG. 9 illustrates the VOIP/PSTN interface 902 and the NIU controller 904 as separate components. In some embodiments, the VOIP/PSTN interface 902 and the NIU controller 904 may be integrated into a single device. In some embodiments, the VOIP/PSTN interface 902 may be combined with the modem 130, the broadband router 140 and/or the NIU controller 904 into a single device. In some embodiments, an optional computer 142 may be used to configure the VOIP/PSTN interface 902 and/or the NIU controller 904. For example, the computer 142 may be coupled to the VOIP/PSTN interface 902 through the router 140. In another example, the VOIP/PSTN interface 902 may be configured for coupling directly to the computer 142.

The system 900 as shown also is coupled to a VOIP/PSTN system provider server 906. For example, the VOIP/PSTN system provider server 906 may comprise a website to which the system 900 is coupled through the Internet 134. In some embodiments, the VOIP/PSTN system provider server 906 may be configured to remotely configure the system 900. For example, the VOIP/PSTN interface 902 may be configured to request configuration from the VOIP/PSTN system provider server 906 in response to certain events. For example, the VOIP/PSTN interface may be configured to detect a new or initial connection to the Internet 134, and to request configuration from the VOIP/PSTN system provider server 906 in response to the detection.

The VOIP/PSTN system provider server 906 may be configured to automatically update the system 900, or to update the system 900 in response to an inquiry from the system 900. For example, the VOIP/PSTN interface 902 may be configured to periodically check for and/or download updates, such as software or firmware updates, from a VOIP/PSTN system provider server 906. The VOIP/PSTN system provider server 906 may be configured to push updates to the system 900. In some embodiments, the VOIP/PSTN system provider server 906 may be configured to send enablement signals to the system 900 (for example, when a call is initiated or periodically), and the system 900 may be configured to disable features (such as VOIP calling) when an expected enablement signal is not received. In another example, the VOIP/PSTN system provider server 906 may be configured to configure the system 900 to use a particular VOIP service provider to provide VOIP service, or to reconfigured the system 900 in response to a request to change to a different VOIP service provider.

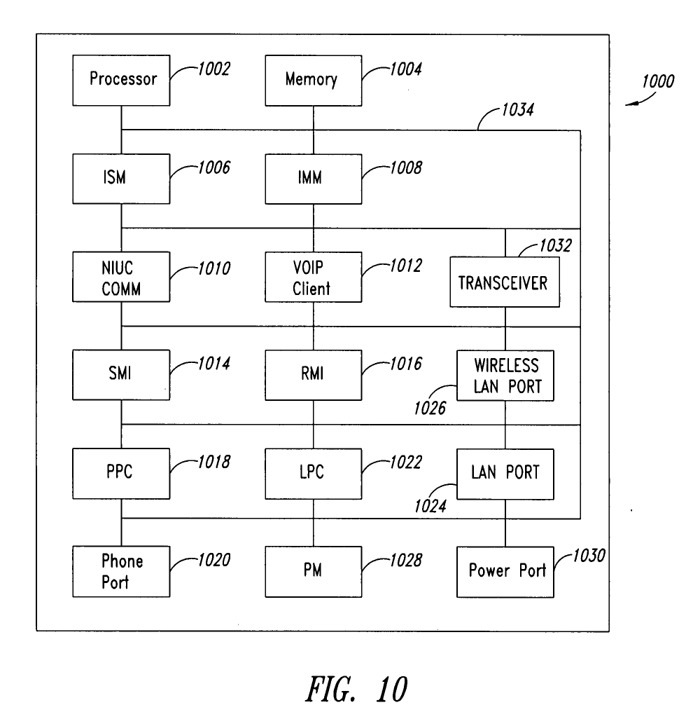

FIG. 10 is a functional block diagram of an embodiment of a VOIP/PSTN interface 1000, suitable for use, for example, in the embodiment of FIG. 9. The VOIP/PSTN interface 1000 comprises a processor 1002, a memory 1004, an interface service module 1006, an interface management module 1008, an NIUC communication module 1010, a VOIP client module 1012, a subscriber management interface module 1014, a remote management interface module 1016, a phone port control module 1018, one or more phone ports 1020, a LAN port control module 1022, one or more LAN ports 1024, one or more wireless LAN ports 1026, a power management module 1028, a power port 1030, one or more transceivers 1032 and a bus system 1034.

The VOIP/PSTN interface 1000 may be implemented in a variety of ways, including as separate subsystems. The VOIP/PSTN interface 1000 may be implemented as a microprocessor, a digital signal processor (DSP), an application-specific integrated circuit (ASIC), firmware, a gate-driver board, discrete circuitry, or the like, or as a series of instructions stored in a memory, such as the memory 1004 and executed by a processor, such as the processor 1002, or as various combinations of the above. Various subsystems or modules, such as the NIUC communication module 1010, are identified as separate blocks in the functional block diagram of FIG. 10 because they perform specific functions that will be described in more detail below. These subsystems may not be discrete units but may be functions of a software routine, which will probably, but not necessarily, be separately callable and hence identifiable elements. The various subsystems may be combined. For example, all or portions of the subscriber management interface 1014 may be integrated into the interface management module 1008. In another example, the LAN port 1024 and the wireless LAN port 1026 may be integrated into the LAN port control module 1022.

The processor 1002 may take the form of one or more standard processors, firmware, a digital signal processor, an application specific integrated circuit or other circuitry and components or combinations thereof, with or without associated memory. The memory 1004 may comprise, for example, registers, read only memory (“ROM”), random access memory (“RAM”), flash memory and/or electronically erasable programmable read only memory (“EEPROM”), and may provide instructions and data for use by the VOIP/PSTN interface 1000. For example, the memory 1004 may store information, such as call routing information, server addresses and protocol information, in one or more data structures.

The interface service module 1006 controls the overall operation of the VOIP/PSTN interface 1000. The interface management module 1008 responds to control and configuration inputs, such as instructions received through the subscriber management interface 1014 and/or the remote management interface 1016.

The NIUC communication module 1010 controls communication with an NIU controller, such as the NIU controller 904 illustrated in FIG. 9. For example, the NIUC communication module 1010 may be configured to generate control signals to control an NIU controller. The control signals may be transmitted to the NIU controller through, for example, the phone port control module 1018 or the LAN port control module 1022. The control signals may comprise, for example, synchronization signals, pulses, analog signals and/or digital signals, and may be transmitted as in-band signals or on carrier signals. In another example, the NIUC communication module 1010 may be configured to respond to control signals received from an NIU controller through, for example, a premises phone network or a wireless LAN.

The VOIP client module 1012 converts PSTN signals into VOIP signals in accordance with a VOIP service provider protocol, and vice versa. The VOIP client module 1012 may be configured to run VOIP client-side software, such as third-party VOIP software, to communicate with a VOIP service provider. The VOIP client module 1012 may be updated or configured, for example, by loading software, data and/or firmware updates, and/or in response to configuration commands. The VOIP client module 1012 may be updated or configured locally and/or remotely.

The subscriber management interface module 1014 receives configuration information from a subscriber, for example, a homeowner, and configures the VOIP/PSTN interface 1000 in response to the configuration information. For example, a subscriber may connect to the VOIP/PSTN interface 1000 using a computer (see computer 142 in FIG. 9) to configure the VOIP/PSTN interface 1000. For example, a subscriber may provide configuration-related information, such as a service provider, a web address and account for a VOIP service provider, a key sequence for placing outbound VOIP calls and/or for using specific carriers. The subscriber management interface module 1014 may be configured to generate control signals to configure the VOIP/PSTN interface 1000 in accordance with the configuration information. For example, the VOIP/PSTN interface 902 may respond to the configuration information by configuring the system 900 to use a selected VOIP service provider. For example, if the configuration information indicates a service provider is not the one that the VOIP/PSTN interface 902 is currently configured to use, the system 900 may be configured to request the selected service provider server 906 to remotely update the VOIP client module 1012.

For example, if the user provides configuration information identifying the “#” key as an indication to use a VOIP service provider, an outbound call without the # key (for example, “15555555555” will be routed via the PSTN 110; but another outbound call with the # sequence (for example, “#15555555555” will be routed through selected VOIP service provider network.

The remote management interface module 1016 receives information and/or commands from remote devices, such as a VOIP/PSTN system provider server (see VOIP/PSTN system provider server 906 in FIG. 9). For example, a VOIP/PSTN system provider server may monitor and/or communicate with the VOIP/PSTN interface 1000 to provide remote management, usage tracking, configuration information and commands, update information and commands (such as software or firmware updates), and/or enablement information and commands, and the remote management interface module 1016 may be configured to process the received information and/or commands. In some embodiments, the remote management interface module 1016 may be configured to request input from remote devices, such as configuration information and commands, update information and commands, and/or enablement information and commands.

The phone port control module 1018 controls communications through one or more phone ports 1020. The phone ports 1020 may be configured for coupling to a premises phone network (see premises phone network 108 in FIG. 9) and/or to one or more analog phones (see analog phone 120 in FIG. 9). In some embodiments, one or more of the phone ports 1020 may be portable phone ports incorporated into the VOIP/PSTN interface 1000. In some embodiments, the system 1000 also comprises one or more transceivers 1032 for sending and/or receiving control signals exchanged between the NIU controller 1102 and a VOIP/PSTN interface (see VOIP/PSTN interface 1000 in FIG. 10). The transceiver 1032 may comprise, for example, one or more transceivers configured to send and/or receive signals over the premises phone network 108, and/or one or wireless transceivers (such as one or more RF, IR, and/or WI-FI transceivers, such as a BlueTooth® compatible transceiver). The transceiver may comprise one or more solid-state frequency generators and/or frequency detectors.

The LAN port control module 1022 controls local area network communications through one or more LAN ports 1024 (such as one or more RJ-45 ports) and/or one or wireless LAN ports 1026 (such as one or more RF, IR, and/or WI-FI transceivers, such as a BlueTooth® compatible transceiver). The LAN Ports may comprise one or more solid-state frequency generators and/or frequency detectors.

The power management module 1028 provides power to the VOIP/PSTN interface 1000. The power port 1030 is configured to receive a power source/signal to power the VOIP/PSTN interface 1000 and the power management module conditions the power signal for use by the VOIP/PSTN interface 1000.

The bus system 1034 may comprise a power bus, control bus, and status signal bus in addition to a data bus. For the sake of clarity, however, the various system buses are illustrated in FIG. 10 as the bus system 1034. Details of the connections of the bus system 1034 to the components of the VOIP/PSTN interface 1000 are omitted for clarity of illustration.

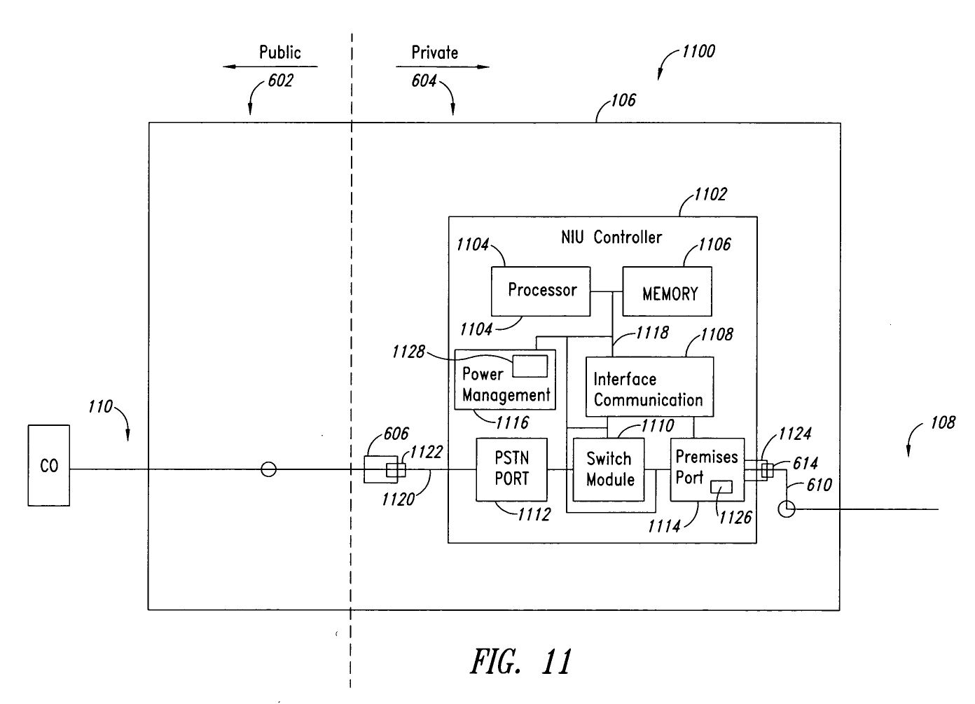

FIG. 11 is a functional block diagram of an embodiment of system 1100 comprising a NIU controller 1102 coupled to an NIU 106. The NIU 106 is coupled to the PSTN 110 and the NIU controller is coupled between the NIU 106 and a premises phone network 108. The NIU controller 1102 may be contained within a case of the NIU 106. The NIU controller 1102 may be configured for mounting adjacent to an NIU 106, and may be configured for mounting on an external surface of a premises, and may comprise a lock (not shown). The NIU controller 1102 comprises a processor 1104, a memory 1106, an interface communication module 1108, a switch module 1110, a PSTN port 1112, a premises port 1114, a power management module 1116 and a bus system 1118. As discussed in more detail herein, the NIU controller 1102 is configured to control the connecting and disconnecting of the PSTN 110 to the premises phone network 108 based in part on signals received from a VOIP/PSTN interface (see VOIP/PSTN interface 1000 in FIG. 10).

The NIU controller 1102 may be implemented in a variety of ways, including as separate subsystems. The NIU controller 1102 may be implemented as a microprocessor, a digital signal processor (DSP), an application-specific integrated circuit (ASIC), firmware, a gate-driver board, discrete circuitry, or the like, or as a series of instructions stored in a memory, such as the memory 1106 and executed by a controller, such as the processor 1104, or as various combinations of the above. Various subsystems or modules, such as the interface communication module 1108, are identified as separate blocks in the functional block diagram of FIG. 11 because they perform specific functions that will be described in more detail below. These subsystems may not be discrete units but may be functions of a software routine, which will probably, but not necessarily, be separately callable and hence identifiable elements. The various subsystems may be combined. For example, all or portions of the switch module 1110 may be integrated into the interface communication module 1108.

The processor 1104 may take the form of one or more standard processors, firmware, a digital signal processor, an application specific integrated circuit or other circuitry and components or combinations thereof, with or without associated memory. The memory 1106 may comprise, for example, registers, read only memory (“ROM”), random access memory (“RAM”), flash memory and/or electronically erasable programmable read only memory (“EEPROM”), and may provide instructions and data for use by the NIU controller 1102. For example, the memory 1106 may store information, such as default switching information and protocol information, which may be stored in one or more data structures.

The processor 1104 controls the overall operation of the NIU controller 1102. The interface communication module 1108 controls communications between the NIU controller 1102 and a VOIP/PSTN interface (see VOIP/PSTN interface 1000 in FIG. 10). For example, the interface communication module 1108 may be configured to generate control signals to control a VOIP/PSTN interface through the premises Port 1114. In another example, the interface communication module 1108 may be configured to detect control signals received from a VOIP/PSTN interface through, for example, a premises phone network or a wireless LAN.

The switch module 1110 is coupled to the PSTN port 1112 and the premises port 1114 and is configured to selectively control the transmission of signals between the PSTN port 1112 and the premises port 1114 in response to control signals. For example, the switch module may be configured to control electrical coupling of the PSTN 110 to the premises phone network 108. The switch module may comprise one or more switches, transistors, electric relays, filters and or other means for partially and/or completely electrically connecting and disconnecting the PSTN 110 from the premises phone network 108 in response to default settings and/or control signals, such as synchronization signals. The switch module 1110 may, for example, respond to control signals by selectively connecting and disconnecting all or part of the premises phone network 108 from the PSTN 110. In another example, the switch module may respond to control signals by selectively applying a filter to connections between the premises phone network 108 and the PSTN 110.

The switch module 1110 may be configured to employ a default connection scheme, and the user may be able to select between several default connection schemes. For example, the switch module 1110 may be configured to default to connecting the premises phone network 108 to the PSTN 110 to enable PSTN calls to be placed and received. The NIU controller 1102 may be configured to default to connecting the PSTN 110 to the premises phone network 108. The switch module 1110 may be configured to open all or part of a connection between the premises phone network 108 and the PSTN 110 (disconnected) when a VOIP communication is initiated or in progress, otherwise the connection may be closed (connected). This embodiment falls back to PSTN mode when VOIP does not work. In another example, the switch module 1110 may be configured to default to opening (disconnecting) all or part of a connection between the premise phone network 108 and the PSTN 110. In this example, the switch module 1110 by default disconnects all or part of the premises phone network 108 from the PSTN 110. When certain events occur, such as a failed attempt to place a VOIP call, the switch module 1110 may be configured to connect the premises phone network 108 to the PSTN 110.

The PSTN port 1112 may comprise, for example, a cord 1120 and a plug 1122 (for example, an RJ-11 plug) configured to couple to a connector 606 (for example, an RJ-11 socket) in the premises connection side 604 that is wired to the PSTN connection side 602. Other means of electrically coupling the PSTN port 1112 to the PSTN 110 may be employed. The premises port 1114 may comprise, for example, a connector 1124 (for example, an RJ-11 socket) configured to receive a connector 614 (for example, an RJ-11 plug) on a short cord 610 coupled to the premises phone network 108. The premises port 1114 also comprises one or more transceivers 1126 for sending and/or receiving control signals exchanged between the NIU controller 1102 and a VOIP/PSTN interface (see VOIP/PSTN interface 1000 in FIG. 10). The transceiver 1126 may comprise, for example, one or more transceivers configured to send and/or receive signals over the premises phone network 108 or another wired network, and/or one or wireless transceivers (such as one or more RF, IR and/or WI-FI transceivers, such as a BlueTooth®) compatible transceiver). The transceiver may comprise, for example, one or more solid-state frequency generators and/or frequency detectors.

The power management module 1116 provides power to the NIU controller 1102, and may comprise a power port 1128 configured to receive a power signal to power the NIU controller 1102. The power management module 1116 may condition power for use by the NIU controller 1102. The power management module 1116 may extract power from the PSTN 110. In some embodiments, the power extracted from the PSTN 110 may be limited, so as to avoid the PSTN mistaking the NIU controller 1102 for a loop current. In some embodiments, the power management module 1116 may extract power from a signal received from a VOIP/PSTN interface (see VOIP/PSTN interface 1000 in FIG. 10), such as a signal received through the premises phone network 108 and/or a wireless signal.

The bus system 1118 may comprise a power bus, control bus, and status signal bus in addition to a data bus. For the sake of clarity, however, the various system buses are illustrated in FIG. 11 as the bus system 1118. Details of the connections of the bus system 1118 to the components of the NIU controller 1102 are omitted for clarity of illustration.

Referring to FIG. 9, in one embodiment the VOIP/PSTN interface 902 and the NIU controller 904 communicate and synchronize with each other using the pre-existed wiring of the premises phone network 108. In this embodiment, additional wiring between the VOIP/PSTN interface 902 and the NIU controller 904 is not required. The VOIP/PSTN interface 902 and the NIU controller 904 may be configured to send and detect a set of signals to control and synchronize their operation. In one embodiment, the signals comprise alternating current (AC) signals with a unique frequency or a set of unique frequencies that are transmittable over the premises phone network 108. To avoid interference with the voice service, each signal frequency may be outside than the human audible range (generally 20-20K Hz). The signal frequencies may also be selected to avoid interference with other services that may also be using the premises phone network (such as dial-up internet service, DSL, alarm system). Confining the signals to the premises phone network also avoids interference with wireless communications, such as those used in WiFi, blue tooth, cordless phone, cell phone, or broadcast signals.

The signals described below may be employed, alone or in various combinations, by embodiments of the system 900. In some embodiments, the signals may be transmitted between the VOIP/PSTN interface 902 and the NIU controller 904 through the premises phone network 108.

In one embodiment, the VOIP/PSTN interface 902 may generate a signal IN_VOIP to cause the NIU controller 904 to perform the tasks necessary to service a VOIP call, such as disconnecting the premises phone network 108 from all or part of the PSTN 110. For example, the VOIP/PSTN interface 902 may apply an IN_VOIP signal to the premises phone network 108 to service a VOIP communication, and may drop the IN_VOIP signal when the communication is finished.

In one embodiment, the VOIP/PSTN interface 902 may be configured to generate a PSTN_ACK signal to indicate to the NIU controller 904 that a PSTN call may be serviced. For example, in response to initiation of a PSTN call, the VOIP/PSTN interface may be configured to disconnect the premises phone network 108 from the local area network 132 and when the disconnection is complete, generate a PSTN_ACK. The NIU controller 904 may be configured to respond to the PSTN_ACK signal by connecting the premises phone network 108 to the PSTN 110 so the PSTN call can be placed.

In one embodiment, the VOIP/PSTN interface 902 may be configured to generate a PSTN_NAK signal when it detects an absence of a PSTN signal on the premises phone network 108. In one embodiment, the VOIP/PSTN interface 902 may be configured to generate a PSTN_NAK signal when it detects an absence of a signal generated by the NIU controller (such as the absence of an IN_PSTN signal, discussed below) on the premises phone network 108.

In one embodiment, the NIU controller 904 may be configured to generate an IN_PSTN signal when servicing a PSTN communication. The VOIP/PSTN interface may respond to an IN_PSTN signal by disabling VOIP communications. The NIU controller 904 may be configured to drop the IN_PSTN signal when it is finished servicing a PSTN communication.

In one embodiment, the NIU controller 904 may be configured to generate a VOIP_ACK signal to indicate to the VOIP/PSTN interface 902 that the NIU controller 902 tasks necessary to provide VOIP service have been completed. For example, the VOIP/PSTN interface 902 may be configured to generate an IN_VOIP signal when it is desired to initiate a VOIP communication, and the NIU controller 904 may be configured to respond to the IN_VOIP signal by disconnecting the premises phone network 108 from the PSTN 110 and sending a VOIP_ACK signal to the VOIP/PSTN interface 902. In response to the VOIP_ACK signal, the VOIP/PSTN interface may be configured to complete the VOIP communication.

In one embodiment, the NIU controller 904 may be configured to generate a VOIP_NAK signal in response to the dropping of an IN_VOIP signal by the VOIP/PSTN interface 902.

In one embodiment, the VOIP/PSTN interface 902 and the NIU controller 904 work together in synchronized fashion to enable both PSTN and VOIP calls on the analog premises phone network 108. When a user is making or receiving a VOIP call, the NIU controller 904 disconnects the premises phone network 108 from the public PSTN 110 and the call is serviced by the VOIP/PSTN interface 902. In this way, the premises phone network 108 temporarily becomes a VOIP-only network. When the user makes or receives a PSTN call, the NIU controller 904 connects the premises phone network 108 to the PSTN 110 and the VOIP/PSTN interface 902 blocks the VOIP channel. In this scenario, the premises phone network 108 temporarily becomes a PSTN-only network. The PSTN calls are serviced by a PSTN telephone service company.

In one embodiment, the VOIP/PSTN interface and the NIU controller communicate and synchronize with each other by applying, dropping and detecting signals with pre-defined patterns over the common physical media, the home phone network system.

In one embodiment, before the NIU controller 902 serves a PSTN call, it applies an IN_PSTN signal to the premises phone network 108. The NIU controller drops the IN_PSTN signal when the PSTN call is finished. The VOIP/PSTN interface 902 is configured not to service any VOIP call requests during the period of time when it detects the IN_PSTN signal on the premises phone network 108. Similarly, when the VOIP/PSTN interface 902 is preparing to service a VOIP call, it applies an IN_VOIP signal to the premises phone network 108. The VOIP/PSTN interface 902 discontinues the IN_VOIP signal when the VOIP call is finished. The NIU controller 904 disconnects the premises phone network 108 from the PSTN 110 in response to the IN_VOIP signal, and keeps the premises phone network 108 disconnected from the PSTN 110 as long as the IN_VOIP signal is detected on the premises phone network 108.

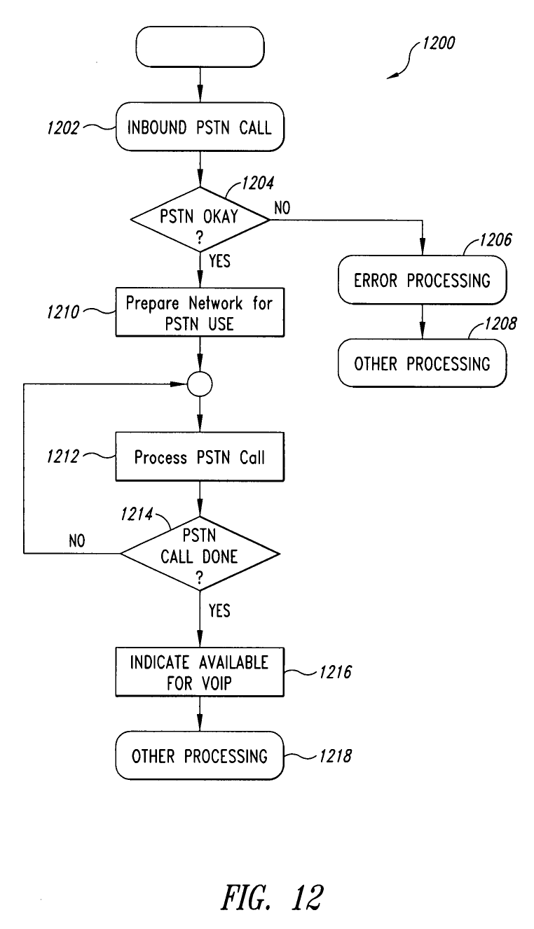

FIG. 12 illustrates an embodiment of a method 1200 of operating a premises communication system, such as the system 900 illustrated in FIG. 9, to process a PSTN call. For convenience, the method 1200 will be described with reference to the system 900 of FIG. 9. At 1202, the system 900 receives an in-bound PSTN call. For example, a PSTN call may be received over the PSTN. The method 1200 proceeds from 1202 to 1204.

At 1204, the system 900 determines whether it is okay to accept an inbound PSTN call through the premises phone network 108. For example, the system may check to see whether a VOIP call is utilizing the premises phone network 108. This may be done, for example, by monitoring a premises phone network to detect an active VOIP call, by checking a flag which is set to disable PSTN calls, by determining whether a signal indicative of an active VOIP call, such as an IN_VOIP signal, is present, or by determining a state of the premises phone network. In some embodiments, such as embodiments where the PSTN is the default network, the system 900 may determine whether it is okay to accept an inbound PSTN call by determining whether the premises phone network 108 is coupled to the PSTN 110. In some embodiments, the NIU controller 904 may be configured to determine whether an inbound PSTN call may be accepted.

When the system 900 determines at 1204 that an inbound PSTN call should not be accepted through the premises phone network, the method 1200 proceeds from 1204 to 1206. At 1206, the system 900 performs error processing. For example, the system 900 may generate a busy signal or message and provide the busy signal or message to the inbound PSTN caller. In another example, the system 900 may offer to record and record a message, which may be stored in a memory for later replaying by the user. In some embodiments, the NIU controller 904 may be configured to perform the error processing. Some embodiments may be configured to let the PSTN handle error processing and/or to generate signals to trigger PSTN error processing. The method 1200 proceeds from 1206 to 1208, where other processing may occur.

When the system 900 determines at 1204 that an inbound PSTN call may be accepted through the premises phone network 108, the method 1200 proceeds from 1204 to 1210. At 1210, the system 900 prepares the premises phone network for use with PSTN calls, if necessary. The preparation may include disabling VOIP use of the premises home network 108, which may comprise, for example, setting a flag or applying or transmitting a signal (such as an IN_PSTN signal) indicating the premises phone network 108 is in use for a PSTN communication. The preparation may include coupling the premises phone network 108 to the PSTN 110. In some embodiments, such as when the PSTN is selected as the default provider, the premises phone network 108 will be connected to the PSTN 110 whenever the premises phone network is not in use for a VOIP call. The method 1200 proceeds from 1210 to 1212.

At 1212, the system 900 processes the PSTN call. This may include, for example, ringing a telephone in a conventional manner and connecting the call in a conventional manner if a telephone set (see telephone sets 120) coupled to the premises phone network 108 answers the call. The method 1200 proceeds from 1212 to 1214.

At 1214, the system 900 determines whether the PSTN call is complete. This may be done, for example, by determining whether a caller has hung up, either without an answer to a ring or after connecting, or by determining whether any of the phones on the premises phone network remain off-hook after connecting to a call. In another example, a voltage level or current flow on the premises phone network may be monitored to determine whether the PSTN call is complete. When the system determines at 1214 that the PSTN call is not complete, the method 1200 proceeds from 1214 to 1212 for further processing of the PSTN call by the system 900.

When the system 900 determines at 1214 that the PSTN call is complete, the method 1200 proceeds from 1214 to 1216. At 1216, the system 900 indicates the premises phone network is not in use in connection with a PSTN communication, such as a PSTN call. In other words, the system 900 indicates that the premises phone network is available for use in connection with either VOIP or PSTN communications. This may be done by, for example, discontinuing a signal indicating the premises phone network 108 is in use for a PSTN call, or resetting a flag previously set to indicate the premises phone network was in use. In some embodiments, the system may be configured to disconnect the premises phone network 108 from the PSTN when it is determined that a PSTN communication is complete. The method proceeds from 1216 to 1218, where further or other processing may occur, such as, for example, returning the value of any desired variables.

Embodiments of the method 1200 may not perform all of the acts shown in FIG. 12, may perform additional acts not shown in FIG. 12, and may perform the acts shown in FIG. 12 in different orders. For example, the method 1200 may be modified to include checking for an indication that VOIP use of the premises phone network 108 has been disabled after act 1210, which may be done before or concurrently with act 1212. The indication that VOIP use of the premises phone network has been disable may comprise a flag or variable setting or the absence or presence of a signal, such as a PSTN_ACK signal. The method 1200 may be configured to perform error processing, which may be done, for example, by a VOIP/PSTN interface, when the indication is not detected, such as adding an entry to an error log.

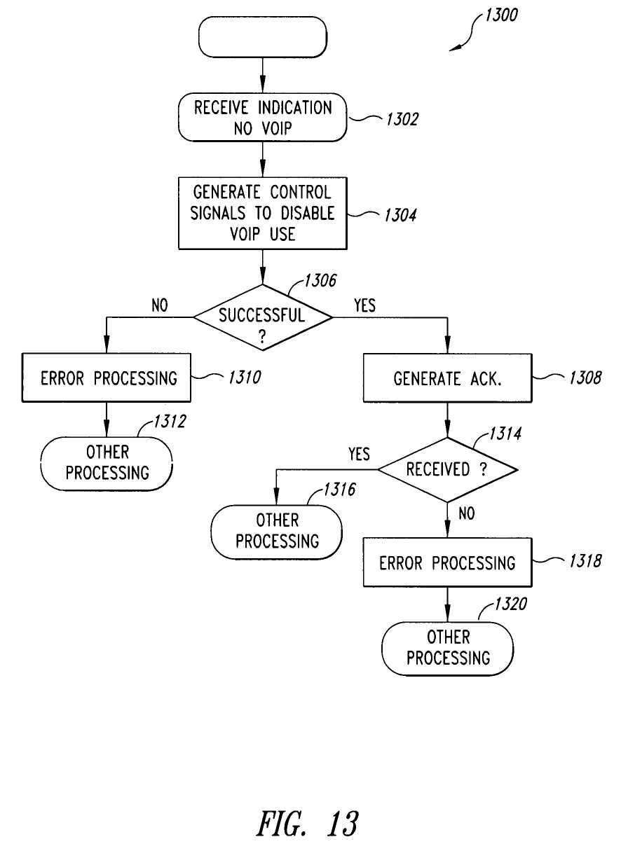

FIG. 13 illustrates a method 1300 of disabling VOIP use of the premises phone network that may be performed by a premises phone system, such as the system 900 illustrated in FIG. 9. At 1302, the system 900 receives or generates an indication that VOIP use should be disabled. The indication may be received or generated, for example, if the system 900 detects an inbound PSTN call or if a VOIP call has concluded. The method 1300 proceeds from 1302 to 1304. At 1304, the system 900 generates control signals to disable VOIP communications over the premises phone network 108. This may be done, for example, by generating control signals to cause the VOIP/PSTN interface 902 to disconnect the premises phone network 108 from VOIP signal sources. In some embodiments the VOIP/PSTN interface 902 and/or the NIU controller 904 may generate the indication and/or the control signals. The method 1300 proceeds from 1304 to 1306.

At 1306, the system 900 determines whether the premises phone network 108 has been successfully disconnected from VOIP signal sources. This may be done, for example, by checking the configuration of the VOIP/PSTN interface. In some embodiments, this may be done by the VOIP/PSTN interface 902. When it is determined that the premises phone network 108 has been successfully disconnected from VOIP signal sources, the method 1300 proceeds from 1306 to 1308, where a signal indicating that the premises phone network is not carrying VOIP-generated communications is generated, such as a PSTN_ACK signal. The signal may be generated, for example, by the VOIP/PSTN interface 902. When it is determined that the premises phone network 108 has not been successfully disconnected from VOIP signal sources, the method 1300 proceeds from 1306 to 1310, where error processing may be performed, such as reattempting the disconnection and/or adding an entry to an error log. The method 1300 proceeds from 1310 to 1312, where other processing may occur.

The method 1300 proceeds from 1308 to 1314. At 1314, the system 900 determines whether the signal indicating the premises phone network is not carrying VOIP-generated communications has been received. This may be done, for example, by the NIU controller 904. When it is determined at 1314 that the signal has been received, the method proceeds from 1314 to 1316, where further processing may occur, such as initiating a PSTN communication. When it is determined at 1314 that the signal has not been received, the method 1300 proceeds from 1314 to 1318, where error processing may occur, such as adding an entry to an error log. The method 1300 proceeds from 1318 to 1320, where further processing may occur.

Embodiments of the method 1300 may not perform all of the acts shown in FIG. 13, may perform additional acts not shown in FIG. 13, and may perform the acts shown in FIG. 13 in different orders. For example, the method 1300 may be modified to omit acts 1306 and 1310.

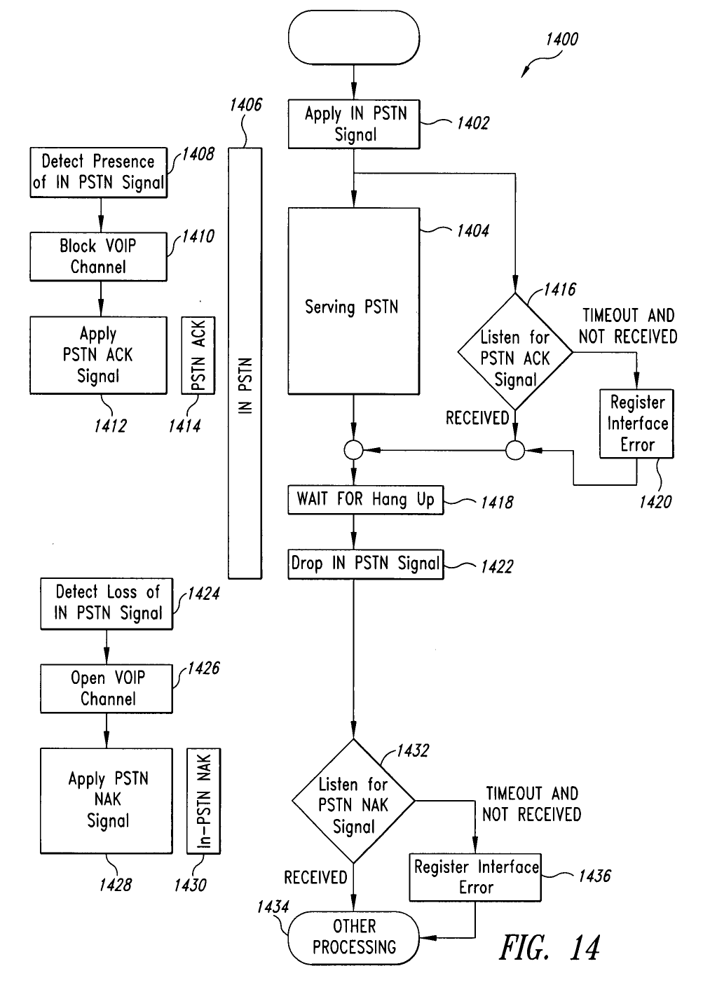

FIG. 14 illustrates another embodiment of a method 1400 of operating a premises communication system, such as the system 900 illustrated in FIG. 9, that may be employed, for example, to serve a PSTN call (inbound or outbound) when the system 900 is ready and is not servicing other calls. For convenience, the method 1400 will be described with reference to the system 900 of FIG. 9. The method 1400 may be performed by other embodiments of a premises communication system, and may be modified for use with such embodiments.

At 1402, the system 900 responds to a PSTN call (for example, an inbound call) by generating a signal indicating a PSTN call is being received or placed, such as an IN_PSTN signal. For convenience, the signal will be referred to as the IN_PSTN signal, which is illustrated as box 1406. The IN_PSTN signal 1406 may be generated, for example, by the NIU controller 904, which may apply the IN_PSTN signal 1406 to the premises phone network. The method 1400 proceeds from 1402 to 1404. At 1404, the PSTN call is serviced. The PSTN call may be serviced by the PSTN 110 acting together with the system 900.

The system 900 detects the IN_PSTN signal 1406 at 1408. The IN_PSTN signal 1406 may be detected, for example, by the VOIP/PSTN interface 902. The method 1400 proceeds from 1408 to 1410, where the system 900 blocks VOIP communications. VOIP communications may be blocked, for example, by the VOIP/PSTN interface 902. The method 1400 proceeds from 1410 to 1412, where the system 900 generates a signal acknowledging the PSTN call, such as a PSTN_ACK signal. For convenience, the signal acknowledging the PSTN call will be referred to as the PSTN_ACK signal, and is illustrated by the box 1414. In one embodiment, the PSTN_ACK signal may be generated by the VOIP/PSTN interface 902.

The method also proceeds from 1402 to 1416. At 1416, the system listens for the PSTN_ACK signal 1414. The NIU controller 904 may, for example, be configured to listen for the PSTN_ACK signal 1414. When the PSTN_ACK signal is timely received, the method proceeds from 1416 to 1418, where the system 900 waits for an indication that the PSTN call has terminated. When the PSTN_ACK signal 1414 is not timely received, the method 1400 proceeds from 1416 to 1420, where error processing may be performed. The method proceeds from 1420 to 1418.

At 1418, the system 900 waits for an indication that the PSTN call has terminated. The indication may comprise a user hanging up a telephone connected to the system 900, such as a telephone 120. When an indication that the PSTN call has terminated is detected, the method proceeds from 1418 to 1422. At 1422, the system discontinues the IN_PSTN signal 1406. For example, the NIU controller 904 may be configured to stop applying an IN_PSTN signal to the premises phone network 108.

The system 900 detects the absence of the IN_PSTN signal at 1424. The VOIP/PSTN interface 902 may be configured to detect the absence of the IN_PSTN signal. The method 1400 proceeds from 1424 to 1426. At 1426, the system enables VOIP communications, by, for example, opening a VOIP communication channel. The VOIP/PSTN interface 902 may be configured to enable VOIP communications. The method 1400 proceeds from 1426 to 1428. At 1428, the system 900 generates a signal acknowledging that the PSTN call has terminated, which is illustrated as, and for convenience will be referred to as, a PSTN_NAK signal 1430. The PSTN_NAK signal may, for example, be generated by the VOIP/PSTN interface 902 and applied to the premises phone network 108.

The method also proceeds from 1422 to 1432, where the system 900 listens for the PSTN_NAK signal 1430. The NIU controller 904 may be configured to listen for the PSTN_NAK signal 1430. When the PSTN_NAK signal 1430 is timely received, the method 1400 proceeds from 1432 to 1434, where other processing may occur. When the PSTN_NAK signal 1430 is not timely received, the method 1400 proceeds from 1432 to 1436, where error processing may occur, such as adding an entry to a VOIP/PSTN interface 902 error log. The method 1400 proceeds from 1436 to 1434.

Embodiments of the method 1400 may not perform all of the acts shown in FIG. 14, may perform additional acts not shown in FIG. 14, and may perform the acts shown in FIG. 14 in different orders. For example, the method 1400 may be modified to omit acts 1416, 1420 and 1436. In another example, flags may be set and cleared, instead of signals, such as the IN_PSTN signal being applied. In another example, some acts may be omitted when an outbound PSTN call is being processed. Some well-known acts, such as wait-state loops, are omitted from FIG. 14 for ease of illustration. The method 1400 may be illustrated or described in other manners, such as separate threads of a process.

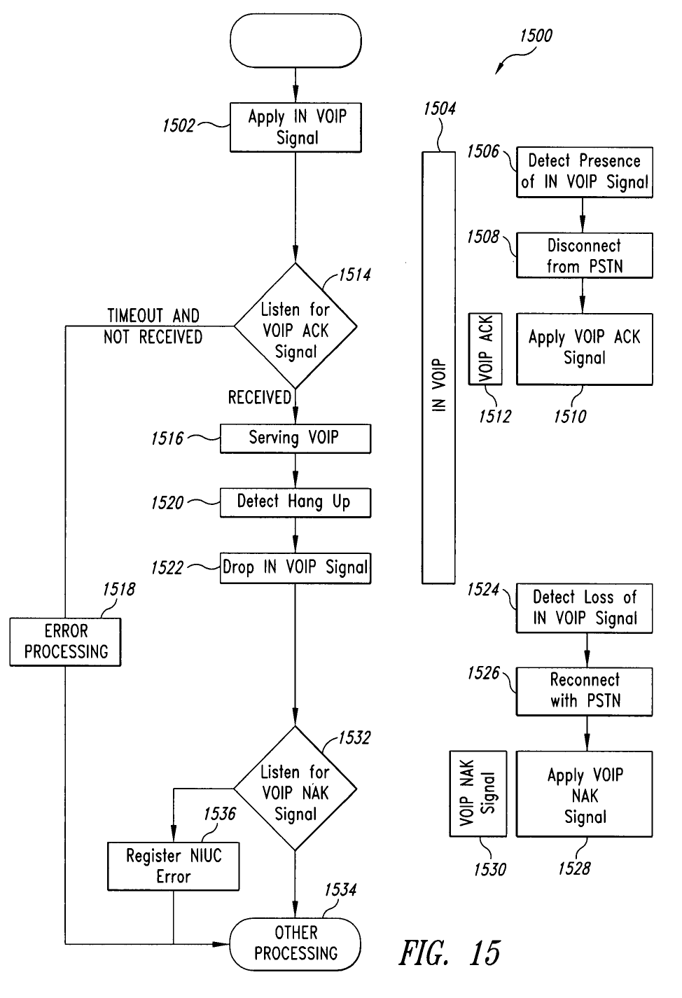

FIG. 15 illustrates an embodiment of a method 1500 of operating a premises communication system, such as the system 900 illustrated in FIG. 9, when an inbound or an outbound VOIP call is initiated with no other active calls on the system. For convenience, the method 1500 will be described with reference to the system 900 of FIG. 9. The method 1500 may be performed by other embodiments of a premises communication system, and may be modified for use with such embodiments.

At 1502, the system 900 applies a signal to indicate a VOIP use of the system 900, such as VOIP use of the premises phone network 108, is desired. The VOIP/PSTN interface 902 may be configured to generate the signal, which is illustrated as, and for convenience will be referred to as, the signal IN_VOIP 1504, and which, for example, may be applied to the premises phone network 108.

At 1506, the system 900 detects the IN_VOIP signal 1504. For example, the NIU controller 904 may be configured to detect the IN_VOIP signal 1504. The method 1500 proceeds from 1506 to 1508. At 1508, the system 900 disconnects the premises phone network 108 from the PSTN 110. For example, the NIU controller 904 may be configured to open one or more switches or relays connecting the premises phone network to the PSTN 110. The method 1500 proceeds from 1508 to 1510. At 1510, the system 900 generates a signal indicating the premises phone network 108 is available for use with VOIP communications, which is illustrated as, and for convenience will be referred to as, the VOIP_ACK signal 1512. The NIU controller 904 may be configured to generate the VOIP_ACK signal 1512, and may, for example, apply the VOIP_ACK signal to the premises phone network 108.

The method 1500 also proceeds from 1502 to 1514. At 1514, the system 900 listens for the VOIP_ACK signal 1512. The VOIP/PSTN interface 902 may be configured to listen for the VOIP_ACK signal 1512. When the VOIP_ACK signal 1512 is timely detected, the method 1500 proceeds from 1514 to 1516. When the VOIP_ACK signal 1512 is not timely detected, the method 1500 proceeds from 1514 to 1518. At 1518, the system 900 may perform error processing, such as advising an inbound caller or a local user that VOIP service is not available, discontinuing the IN_VOIP signal 1512, and/or offering to take a message from an inbound caller. The VOIP/PSTN interface 902 may be configured to perform the error processing. The method 1500 proceeds from 1518 to 1534, where other processing may be performed.

At 1516, the system 900, in combination with a VOIP service provider, services the VOIP communication. The VOIP/PSTN interface 902 may be configured to service the VOIP communication. The method 1500 proceeds from 1516 to 1520. At 1520, the system 900 waits for an indication that the VOIP communication has terminated, such as a user on a local or remote phone hanging up. The VOIP/PSTN interface 902 may be configured to detect the indication that the VOIP communication has terminated. The method proceeds from 1520 to 1522. At 1522, the system 900 discontinues the IN_VOIP signal 1504. For example, the VOIP/PSTN interface 902 may be configured to discontinue an IN_VOIP signal.

At 1524, the system 900 detects the loss of the IN_VOIP signal 1504. For example, the NIU controller 904 may be configured to detect the loss of the IN_VOIP signal 1504. The method 1500 proceeds from 1524 to 1526. At 1526, the system 900 connects the premises phone network 108 to the PSTN 110. For example, the NIU controller 904 may be configured to close one or more switches or relays connecting the premises phone network to the PSTN 110. The method 1500 proceeds from 1526 to 1528. At 1528, the system 900 generates a signal acknowledging the termination of the VOIP call, which is illustrated as, and for convenience will be referred to as, the VOIP_NAK signal 1530. The NIU controller 904 may be configured to generate the VOIP_NAK signal 1530, and may, for example, apply the VOIP_NAK signal to the premises phone network 108.

The method 1500 proceeds from 1522 to 1532. At 1532, the system 900 listens for the VOIP_NAK signal 1530. The VOIP/PSTN interface 902 may be configured to listen for the VOIP_NAK signal 1530. When the VOIP_NAK signal 1530 is timely detected, the method 1500 proceeds from 1532 to 1534, where other processing may be performed. When the VOIP_NAK signal 1530 is not timely detected, the method 1500 proceeds from 1532 to 1536. At 1536, the system 900 may perform error processing, such as adding an entry to an error log indicating an NIU controller 904 error. The VOIP/PSTN interface 902 may be configured to perform the error processing. The method 1500 proceeds from 1536 to 1534, where other processing may be performed.

Embodiments of the method 1500 may not perform all of the acts shown in FIG. 15, may perform additional acts not shown in FIG. 15, and may perform the acts shown in FIG. 15 in different orders. For example, the method 1500 may be modified to omit act 1536. In another example, flags may be set and cleared, instead of signals, such as the IN_VOIP signal 1504 being applied. Some well-known acts, such as wait-state loops, are omitted from FIG. 15 for ease of illustration. The method 1500 may be illustrated or described in other manners, such as separate threads of a process.

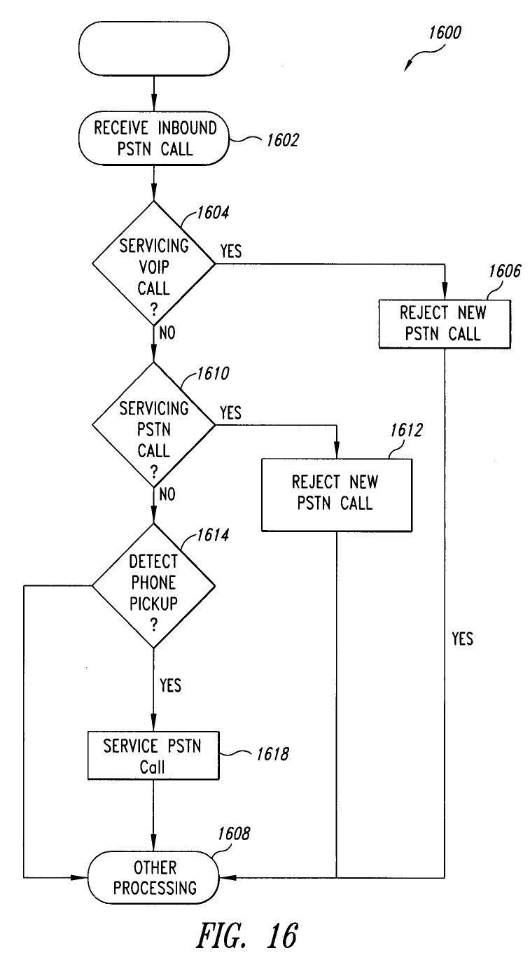

FIG. 16 illustrates an embodiment of a method 1600 of operating a premises communication system, such as the system 900 illustrated in FIG. 9, when an inbound PSTN call request is received. The method 1600 may determine whether and how to service the inbound call. For convenience, the method 1600 will be described with reference to the system 900 of FIG. 9. The method 1600 may be performed by other embodiments of a premises communication system, and may be modified for use with such embodiments.

At 1602, the system 900 receives an inbound PSTN call. The method 1600 proceeds from 1602 to 1604. At 1604, the system 900 checks to see whether a VOIP call is in progress. The NIU controller 904 may be configured to check whether a VOIP call is in progress by checking to see if the premises phone network 108 is coupled to the PSTN 110, by, for example, checking to see if switches or relays coupling the premises phone network 108 to the PSTN 110 are open.

When it is determined that a VOIP call is in progress, the method 1600 proceeds from 1604 to 1606, where the system 900 may perform other processing, such as generating control signals to cause the system 900 or the PSTN 110 to indicate to the caller that the system 900 cannot accept the inbound PSTN call, to indicate to the user that a PSTN call is waiting, or message processing. For example, an audible signal may be applied to the premises home network 108 to let the user know a PSTN call is waiting. The NIU controller 904 alone or in combination with the VOIP/PSTN interface 902 may be configured to perform the processing at 1606. The method proceeds from 1606 to 1608, where other processing may occur.

When it is determined at 1604 that a VOIP call is not in progress, the method proceeds from 1604 to 1610. At 1610, the system 900 determines whether an existing PSTN call is in progress. The NIU controller 904 may be configured to determine whether an existing PSTN call is in progress.

When the system 900 determines at 1610 that an existing PSTN call is in progress, the method proceeds from 1610 to 1612. At 1612, the PSTN service provider and/or the system 900 may perform processing for a PSTN call received while the system is handling another PSTN call, such as busy-signal processing, call-waiting processing and/or message processing. The method 1600 proceeds from 1612 to 1608.

When the system 900 determines at 1610 that an existing PSTN call is not in progress, the method 1600 proceeds from 1610 to 1614. At 1614, the system 900 determines whether the inbound PSTN call has been answered. This may be done, for example, by detecting the existence of a current loop. The NIU controller 904 may be configured to determine whether the inbound PSTN call has been answered. When it is determined at 1614 that the call has been answered, the method proceeds from 1614 to 1618. At 1618, the system 900 services the PSTN call. In one embodiment, the system 900 may service the PSTN call by calling all or part of the method 1500 illustrated in FIG. 14. The method 1600 proceeds from 1618 to 1608, where other processing may occur.

Embodiments of the method 1600 may not perform all of the acts shown in FIG. 16, may perform additional acts not shown in FIG. 16, and may perform the acts shown in FIG. 16 in different orders. For example, in some embodiments the PSTN may determine whether an existing PSTN call is being serviced and process the inbound PSTN call without involvement of the system 900 (for example, by providing an inbound PSTN caller with a busy signal). Thus, in some embodiments acts 1610 and 1612 may be omitted or performed by the PSTN before act 1602. In another example, the PSTN may provide a call-waiting signal to the system 900, and the system 900 may process the call, for example, as described above in act 1612. Some well-known acts, such as wait-state loops, generating ring tones, etc., are omitted from FIG. 16 for ease of illustration. The method 1600 may call one or more subroutines or perform one or more other methods, such as all or portions of the methods 1200, 1300 and/or 1400 illustrated in FIGS. 12 through 14. The method 1600 may be illustrated or described in other manners, such as separate threads of a process.

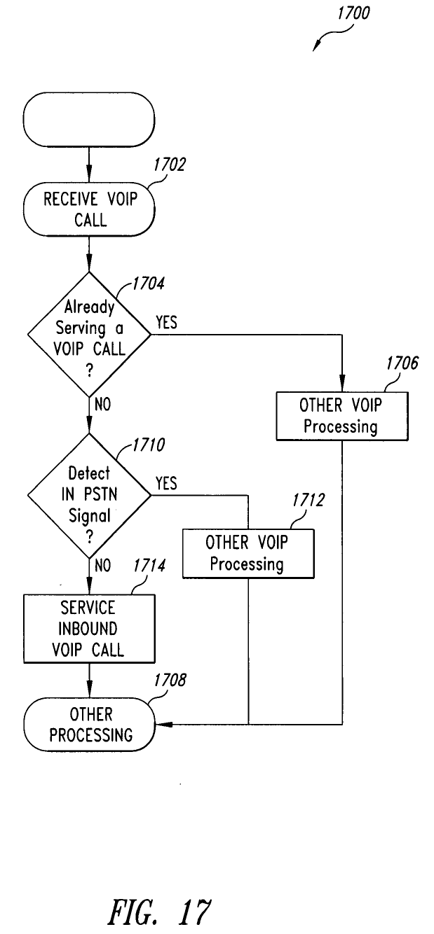

FIG. 17 illustrates an embodiment of a method 1700 of operating a premises communication system, such as the system 900 illustrated in FIG. 9, when an inbound VOIP call is received. For convenience, the method 1700 will be described with reference to the system 900 of FIG. 9. The method 1700 may be performed by other embodiments of a premises communication system, and may be modified for use with such embodiments.

At 1702, the system 900 receives an inbound VOIP call. The method 1700 proceeds from 1702 to 1704. At 1704, the system 900 checks to see whether another VOIP call is in progress. The VOIP/PSTN interface 902 may be configured to check whether another VOIP call is in progress.

When it is determined that another VOIP call is in progress, the method 1700 proceeds from 1704 to 1706, where the system 900 may perform other processing of the inbound VOIP call, such as generating control signals to cause the system 900 or the VOIP service provider to indicate to the caller that the system 900 cannot accept the inbound VOIP call, or providing other services, such as call-waiting or message processing. The VOIP/PSTN interface 902 may be configured to perform the processing at 1706. The processing may comprise generating control signals to cause a VOIP servicer provider to provide call services. The method proceeds from 1706 to 1708, where other processing may occur.

When it is determined at 1704 that another VOIP call is not in progress, the method proceeds from 1704 to 1710. At 1710, the system 900 determines whether an existing PSTN call is in progress. For example, the VOIP/PSTN interface 902 may be configured to determine whether a PSTN call is in progress by, for example, checking for an IN_PSTN signal.

When the system 900 determines at 1710 that an existing PSTN call is in progress, the method 1700 proceeds from 1710 to 1712. At 1712, the system 900 may perform processing for a VOIP call received while the system is handling a PSTN call, such as busy-signal processing, VOIP call-waiting processing, and/or message processing. For example, an audible signal may be applied to the premises home network to let the user know a VOIP call is waiting. The method 1700 proceeds from 1712 to 1708.

When the system 900 determines at 1710 that an existing PSTN call is not in progress, the method 1700 proceeds from 1710 to 1714. At 1714, the system 900 services the inbound VOIP call. In one embodiment, the system 900 may service the PSTN call by calling all or part of the method 1500 illustrated in FIG. 15. The method 1700 proceeds from 1714 to 1708, where other processing may occur.

Embodiments of the method 1700 may not perform all of the acts shown in FIG. 17, may perform additional acts not shown in FIG. 17, and may perform the acts shown in FIG. 17 in different orders. For example, act 1712 may be omitted and the system 900 may rely on existing mechanisms of the PSTN, as provided by a PSTN carrier, to provide busy signals, call waiting, voice mail, etc. For example, the method 1700 may be modified to determine whether the inbound VOIP call is timely answered by a telephone 120 coupled to the premises phone network 108, and to perform other VOIP processing when the inbound VOIP call is not timely answered. Some well-known acts, such as wait-state loops, are omitted from FIG. 17 for ease of illustration. The method 1700 may call one or more subroutines or perform one or more other methods, such as all or part of the method 1500 illustrated in FIG. 15. The method 1700 may be illustrated or described in other manners, such as separate threads of a process.

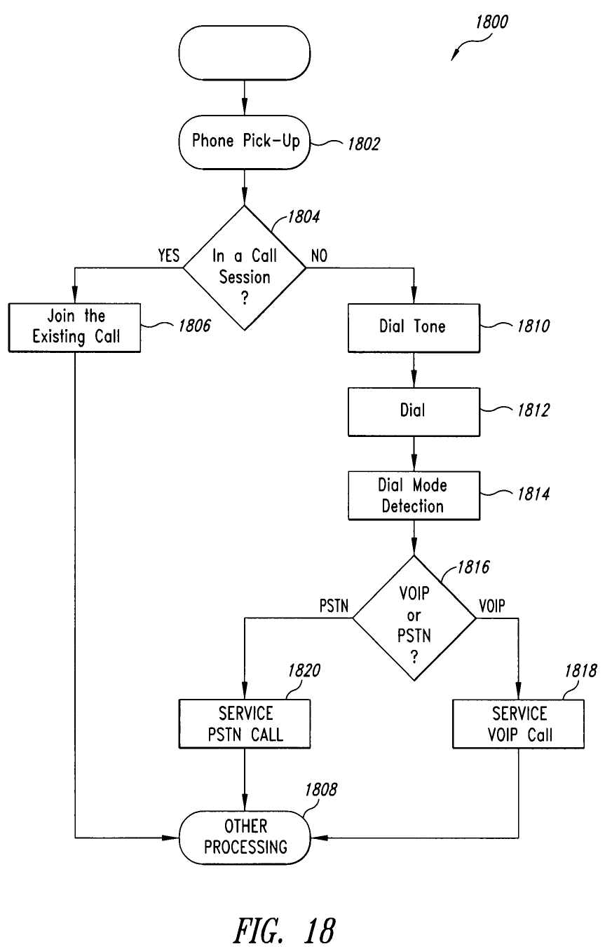

FIG. 18 illustrates an embodiment of a method 1800 of operating a premises communication system, such as the system 900 illustrated in FIG. 9, when an outbound call is initiated. Embodiments of this method may be used for both PSTN and VOIP outbound calls. For convenience, the method 1800 will be described with reference to the system 900 of FIG. 9. The method 1800 may be performed by other embodiments of a premises communication system, and may be modified for use with such embodiments.

At 1802, the system 900 receives an indication that a user wishes to place an outbound call. For example, a user may pick up a telephone 120 coupled to the premises phone network 108. The method 1800 proceeds from 1802 to 1804. At 1804, the system 900 checks to see whether another call is in progress. The VOIP/PSTN interface 902 and/or the NIU controller 904 may be configured to check whether another call is in progress. In some embodiments, the caller may check to see whether another call is in progress by listening for a dial tone or an ongoing phone conversation.

When it is determined that another call is in progress, the method 1800 proceeds from 1804 to 1806, where the system 900 joins the telephone 120 which was picked up to the existing call. The method 1800 proceeds from 1806 to 1808, where other processing may occur.

When it is determined at 1804 that another call is not in progress, the method proceeds from 1804 to 1810. At 1810, the system 900 provides a dial tone to the user, for example, to the telephone 120. The VOIP/PSTN interface 902 and/or the NIU controller 904 may be configured to provide the dial tone (by, for example, connecting the premises phone network to the PSTN). The method 1800 proceeds from 1810 to 1812, where the system 900 waits for a telephone number and/or command sequence to be entered by a user. The method 1800 proceeds from 1812 to 1814, where the system 900 selects a VOIP or a PSTN service provider to service the call based on the telephone number and/or command sequence. The selection may also be based on the available service providers or other conditions, such as a loss of a PSTN service carrier, loss of a VOIP service provider, and/or of power to the VOIP/PSTN interface. The VOIP/PSTN interface 902 and/or the NIU controller 904 may be configured to select a service provider. The method 1800 proceeds from 1814 to 1816.

At 1816, the system 900 determines whether to service the call using a VOIP service provider or a PSTN service provider. The VOIP/PSTN interface 902 and/or the NIU controller 904 may be configured to make this determination. When it is determined to service the call using a VOIP service provider, the method proceeds from 1816 to 1818, where the system 900 together with a VOIP service provider service the call. The method 1800 may service the VOIP call by calling one or more subroutines or performing one or more other methods, such as all or part of the method 1500 illustrated in FIG. 15. The method 1800 proceeds from 1818 to 1808, where other processing may occur.

When it is determined to service the call using a PSTN service provider, the method proceeds from 1816 to 1820. At 1820, the system 900, together with the PSTN, services the outbound PSTN call. The method 1800 may service the outbound PSTN call by calling one or more subroutines or performing one or more other methods, such as all or part of the method 1400 illustrated in FIG. 14.

Embodiments of the method 1800 may not perform all of the acts shown in FIG. 18, may perform additional acts not shown in FIG. 18, and may perform the acts shown in FIG. 18 in different orders. For example, the method 1800 may be modified to detect completion of as PSTN call, and to generate and detect a PSTN_NAK signal after completion of the PSTN call is detected. Some well-known acts, such as wait-state loops, are omitted from FIG. 18 for ease of illustration. The method 1800 may be illustrated or described in other manners, such as separate threads of a process.

In some embodiments, such as those shown in FIGS. 9 through 18, the system may be configured to allow a system provider, such as a VOIP service provider and/or a VOIP/PSTN premises system provider, to monitor system usage and/or error processing in real time or periodically, and may provide system updates or generate control signals in response to the monitoring. The monitoring may be provided as a subscription service and/or used in connection with system billing and/or service enhancement. The ability to remotely monitor the usage and push program and data to installed systems of this invention enables the system provider to generate revenue from a number of subscription based models, such as pay by usage. The various system and/or services providers, such as a premises system provider, can also deliver advertising messages and other data services to the installed systems. For example, the cost to a user of using the systems can be subsidized if users agree to listen to advertising messages. For example, before placing a call or retrieving message, a user may be asked to listen to advertising messages. For a fee, the user may be able to skip advertising messages. The premises phone system and/or the VOIP/PSTN system provider server may be configured to monitor system activity and generate billing and invoices based on the usage. For example, the VOIP/PSTN system provider server 906 may monitor how many users listened to a particular advertisement, and generate an invoice to the advertiser.

Example embodiments discussed above illustrate functional component structures for the VOIP/PSTN interface and the NIU controller (see FIGS. 9, 10 and 11). There are alternative ways of hardware implementation. For example, FIG. 9 illustrates the VOIP/PSTN interface 902 and the NIU controller 904 as two separate hardware units installed at different locations in the analog phone network 102 and broadband network 104. For example, the VOIP/PSTN interface 902 is a piece of hardware that bridges the broadband router 140 and the analog phone network 102, and the NIU controller 904 is a small piece of hardware installed inside the NIU 106 connecting the PSTN 110 and the analog phone network 102. This embodiment may be advantageously employed when the above-mentioned connection points for the VOIP/PSTN interface 902 and the NIU controller 904 are far apart.

In some embodiments, the functionalities of the VOIP/PSTN interface 902 and the NIU controller 904 may be integrated into one hardware unit. For example, in one embodiment, the VOIP/PSTN interface 902 and the NIU controller 904 functions remain, but a single piece of hardware is configured to perform these functions. This embodiment may be advantageously employed, for example, in connection with DSL broadband service. In some embodiments, a single hardware unit may perform the functions of the modem 130 and the router 140, as well as the functions of the VOIP/PSTN interface 902 and/or the NIU controller 904.

In one embodiment, the NIU controller does not receive and save any VOIP configuration data. In another embodiment, the VOIP/PSTN interface 902 is configured to send the VOIP dial sequences to the NIU controller 904, and the NIU controller 904 and the VOIP/PSTN interface 902 can determine the call mode for an outbound call separately, which can reduce the number of control signals, such as synchronization signals, transmitted between the NIU controller 904 and the VOIP/PSTN interface 902.

In one embodiment, a computer readable memory medium contains contents, such as instructions, which cause a processor or controller to perform the methods described herein.

Voice signals are typically in the range of 0-4 kHz. As mentioned above, some embodiments may employ DSL broadband service providers. DSL has many different formats. Two major formats are Carrierless Amplitude Phase (“CAP) and Discrete Multi-Tone (“DMT”). For CAP, upstream frequencies are typically in the ranges of 25 kHz to 160 kHz, and downstream frequencies are typically between 240 kHz and 1.5 MHz. For DMT, upstream frequencies are typically in the range of 25-138 kHz, with 25 upstream bins employed. Downstream frequencies are typically between 138 kHz and 1104 kHz, with 32-255 downstream bins employed. Both CAP and DMT have 4 k to 25 k unused as guard frequency range. Thus, embodiments of the premises phone system, such as the embodiment of the system 900 illustrated in FIG. 9, may use a portion of the 4 kHz to 25 kHz range without interfering with DSL signals. Frequencies over 10 kHz are generally not noticeable by the human ear. As an option, for CAP standard, some embodiments of the system may use signals between 160 kHz and 240 kHz without interfering with CAP signals.

In some embodiments, the system may be configured to selectively block only low frequency or voice frequency communications between the PSTN and the premises phone network. Thus higher frequency signals, such as DSL signals and premises phone system signals may be allowed to go through after the system has disconnected or blocked PSTN signals.

In some embodiments, the system may be configured to detect the presence of a PSTN Central Office voltage. For example, the VOIP/PSTN interface may be configured to detect whether a voltage, such as 48 volts, is present on the premises phone network 108. When the voltage is present, the system 900 may rely on the PSTN service provider to provide a dial tone. The VOIP/PSTN interface may also be configured to detect a dial tone as an indication of initiating an outbound call.

In some embodiments, the VOIP/PSTN interface 902 may be configured to provide a voltage of approximately 4 volts to the premises phone network 108. As mentioned above with reference to FIG. 9, circuitry such as a diode 903 may be employed to block reverse current flow when the voltage provided by the PSTN 110 (typically 48 volts) is larger than the internal voltage of the VOIP/PSTN interface 902. This will reduce the possibility of interference by the VOIP/PSTN interface 902 in the operation of the PSTN 110, and noise that may occur as a result of dual dial tones that may be generated while the premises phone system 900 determines which provider to use for an outbound call. (See FIG. 18).

Although specific embodiments of and examples are described herein for illustrative purposes, various equivalent modifications can be made without departing from the spirit and scope of this disclosure, as will be recognized by those skilled in the relevant art. The various embodiments described above can be modified and/or combined to provide further embodiments.

These and other changes can be made to the invention in light of the above-detailed description. In general, in the following claims, the terms used should not be construed to limit the invention to the specific embodiments disclosed in the specification and the claims. Accordingly, the invention is not limited by the disclosure, but instead its scope is to be determined entirely by the following claims.

What is claimed is:

1. A voice-over-internet-protocol (VOIP)/public-switching-telephone-network (PSTN) control system, comprising:
a VOIP/PSTN interface comprising:
a first port configured to receive and transmit VOIP-compatible communication signals;
a second port configured to receive and transmit PSTN-compatible communication signals;
a VOIP client module configured to convert received VOIP-compatible communication signals and to convert PSTN-compatible communication signals; and
a communication module configured to generate control signals to control coupling of a premises phone network to a PSTN provider network; and
a network-interface-unit-controller configured to selectively couple the premises phone network to the PSTN provider network in response to the control signals.

2. The system of claim 1, wherein the communication module is configured to output the control signals through the second port.

3. The system of claim 2 wherein the communication module comprises a solid-state frequency generator configured to generate the control signals.

4. The system of claim 3 wherein the network-interface-unit-controller comprises a solid-state frequency detector configured to detect control signals.

5. The system of claim 4 wherein the control signals comprise signals selected to minimize interference with existing PSTN signals.

6. A voice-over-Internet-protocol/public-switching-telephone-network interface, comprising:
a first port configured to receive and transmit voice-over-internet-protocol-compatible signals;
a second port configured to receive signals from a public-switching-telephone-network;
a client module configured to convert voice-over-internet-protocol-compatible signals and to convert public-switching-telephone-network-compatible analog voice signals; and
a communication module configured to generate control signals to control coupling of a premises phone network to the public-switching-telephone-network.

7. The interface of claim 6 wherein the communication module is configured to transmit at least one of the control signals through the second port.

8. The interface of claim 6 wherein the communication module comprises a solid-state frequency generator configured to generate at least one of the control signals.

9. The interface of claim 8 wherein the communication module comprises a solid-state frequency detector configured to detect control signals.

10. The interface of claim 6 further comprising:
a bi-polar transistor configured to control coupling of the interface to the premises phone network.

11. The interface of claim 6, wherein the second port is configured to couple to the premises phone network and to provide a voltage of approximately 4 volts to the premises phone network.

12. The interface of claim 6 wherein the control signals comprise synchronization signals.

13. The interface of claim 6 wherein the communication module comprises a wireless transceiver configured to transmit the control signals.

14. The interface of claim 12 wherein the wireless transceiver is configured to receive control signals.

15. The interface of claim 6 wherein the first port comprises a wireless transceiver.

16. The interface of claim 6 wherein the second port comprises a wireless transceiver.

17. The interface of claim 6, further comprising:
a controller configured to selectively couple the premises phone network to the public-switching-telephone-network in response to the control signals.

18. A controller, comprising:
a first port configured to couple to an analog premises phone network;
a second port configured to couple to a public-switching-telephone-network; and
a switch module configured to respond to control signals by selectively controlling the transmission of signals between the first port and the second port.

19. The controller of claim 18 wherein the second port is configured to couple to a network-interface-unit.

20. The controller of claim 18 wherein the switch module comprises a relay configured to selectively open a connection between the first port and the second port in response to the control signals.
